(19) United States
(12) Patent Application Publication
(10) Pub. No.: US 2026/0186443 A1
(43) Pub. Date: Jul. 2, 2026

(54) CARTRIDGE, AND IMAGE FORMING APPARATUS

(71) Applicant: Zhuhai Pantum Electronics Co., Ltd., Zhuhai (CN)

(72) Inventors: Leifeng ZHU, Zhuhai (CN); Zhe SHAO, Zhuhai (CN); Yihong ZHANG, Zhuhai (CN); Yuying LU, Zhuhai (CN)

(21) Appl. No.: 19/425,492

(22) Filed: Dec. 18, 2025

(30) Foreign Application Priority Data
Dec. 26, 2024 (CN) 202411948666.X

(51) Int. Cl. G03G 21/18; G03G 21/16

(52) U.S. Cl. CPC G03G 21/1864; G03G 21/1647; G03G 21/1814; G03G 21/1828; G03G 2221/1603; G03G 2221/1654; G03G 2221/1657

(57) ABSTRACT

A cartridge, the cartridge including a housing and a first rotate member arranged on the housing, the adapter includes: a first unlock mechanism for unlocking a drive force driving the first rotate member, so that the first rotate member may rotate during operation.

### CROSS-REFERENCE TO RELATED APPLICATION(S)

This application claims priority to Chinese Patent Application No. 202411948666.X filed on Dec. 26, 2024, which is incorporated herein by reference in its entirety.

### FIELD OF THE TECHNOLOGY

The present disclosure relates to a field of image forming technology, and in particular to a cartridge, and an image forming apparatus.

### BACKGROUND

Image forming device is a device that forms an image on a print medium based on an input signal. Products such as laser printers, copiers, and multifunction printers all contain a cartridge. The cartridge typically includes a drum assembly and a develop assembly. To ensure proper cartridge operation, both the drum assembly and the develop assembly have a connection point to the body. This connection point receives the drive force transmitted from the body, which drives the cartridge to rotate and form the image.

In certain existing technology, the cartridge is installed into the printer by the user pushing it in, which overcomes the compressive force of the printer's drive source, thus achieving a normal connection between the cartridge and the printer. However, during operation, excessive force may cause the printer to directly impact the cartridge, resulting in impact damage.

### SUMMARY

In one aspect, the present disclosure provides an adapter, configured to be arranged on a cartridge, the cartridge including a housing and a first rotate member arranged on the housing, the adapter including: a first unlock mechanism for unlocking a drive force driving the first rotate member, so that the first rotate member may rotate during operation.

In another aspect, the present disclosure provides a cartridge, including: a housing; a first rotate member arranged on the housing; a first unlock mechanism for unlocking the drive force driving the first rotate member, so that the first rotate member rotates during operation.

In yet another aspect, the present disclosure provides an image forming apparatus, including: a body and a cartridge being detachably arranged to the body, where the cartridge includes: a housing; a first rotate member arranged on the housing; a first unlock mechanism for unlocking the drive force driving the first rotate member, so that the first rotate member rotates during operation.

In yet another aspect, the present disclosure provides an image forming apparatus. The apparatus includes: body provided with an insertion port for receiving a cartridge; a third rotate member arranged on the body, the third rotate member being used to engage with a first rotate member of the cartridge; a first restrain mechanism arranged on the body, wherein when the cartridge is not inserted into the image forming apparatus body, the first restrain mechanism is used to limit the third rotate member to a first position; when the cartridge is inserted into the image forming apparatus body and installed in place, a first unlock mechanism of the cartridge cooperates with the first restrain mechanism to allow the third rotate member to be positioned in a second position, thereby releasing the restriction of the first restrain mechanism on the third rotate member and achieving engagement between the first rotate member and the third rotate member.

### BRIEF DESCRIPTION OF THE DRAWINGS

The following drawings are incorporated herein by reference as part of the present disclosure and are used to for understanding the present disclosure. The drawings illustrate certain embodiments of the present disclosure, serving to explain the apparatus and principles of the present disclosure. In the drawings:

FIG. 1 is a partial perspective view of an image forming apparatus according to certain embodiments of the present disclosure;

FIG. 2 is a perspective view of a cartridge according to certain embodiments of the present disclosure;

FIG. 3 is a partial perspective view of the housing of the cartridge shown in FIG. 2 according to certain embodiments;

FIG. 4 is a partial perspective view of the housing of the cartridge according to certain embodiments shown in FIG. 2;

FIG. 5a is an end view of the cartridge shown in FIG. 1;

FIG. 5b is an end view of the cartridge shown in FIG. 1;

FIG. 6 is a partial perspective view of the body of the image forming apparatus shown in FIG. 1;

FIG. 7 is a front view of the first drive source shown in FIG. 6, where the first restrain mechanism is located in the restricted position;

FIG. 8 is a cross-sectional view of the first drive source shown in FIG. 7;

FIG. 9 is a perspective view of the first drive source shown in FIG. 6, where the first restrain mechanism is located in the released position;

FIG. 10 is a front view of the first drive source shown in FIG. 9;

FIG. 11 is a cross-sectional view of the first drive source shown in FIG. 10;

FIG. 12 is a perspective view of the cartridge shown in FIG. 2 arranged on the body;

FIG. 13 is a partial enlarged view of FIG. 12;

FIG. 14 is another partial perspective view of the image forming apparatus shown in FIG. 1, where the first restrain mechanism is located in the released position;

FIG. 15 is another partial perspective view of the image forming apparatus shown in FIG. 1, where the first restrain mechanism is located in the restricted position;

FIG. 16 is a partial perspective view of the image forming apparatus according to certain embodiments of the present disclosure;

FIG. 17 is another partial perspective view of the image forming apparatus shown in FIG. 16;

FIG. 18 is a perspective view of the lock member shown in FIG. 15;

FIG. 19 is a top view of the lock member shown in FIG. 18;

FIG. 20 is a front view of the lock member shown in FIG. 19;

FIG. 21 is a partial perspective view of an image forming apparatus according to certain embodiments of the present disclosure, where the first unlock position is in the retracted position;

FIG. 22 is a partial perspective view of the image forming apparatus shown in FIG. 21, where the first unlock mechanism is in the extended position;

FIG. 23 is a partial perspective view of an image forming apparatus according to certain embodiments of the present disclosure, wherein the first unlock position is located in the folded position;

FIG. 24 is a partial perspective view of the image forming apparatus shown in FIG. 23, where the first unlock mechanism is located in the extended position;

FIG. 25 is a partial perspective view of an image forming apparatus according to certain embodiments of the present disclosure, wherein the first unlock position is located in the folded position;

FIG. 26 is a perspective view of the image forming apparatus shown in FIG. 25, where the first unlock position is located in the extended position;

FIG. 27 is a partial perspective view of an image forming apparatus according to certain embodiments of the present disclosure, wherein the first unlock position is located outside the area formed by the first rotate member and the second rotate member;

FIG. 28 is a partial perspective view of an image forming apparatus according to certain embodiments of the present disclosure;

FIG. 29 is a partial perspective view of the housing of the image forming apparatus shown in FIG. 1;

FIG. 30 is a partial perspective view of an image forming apparatus according to certain embodiments of the present disclosure, wherein the first restrain mechanism is located in a restricted position;

FIG. 31 is a perspective view of the image forming apparatus shown in FIG. 30, where the first restrain mechanism is located in the released position;

FIG. 32 is a perspective view of the first restrain mechanism shown in FIG. 30;

FIG. 33 is a top view of the first restrain mechanism shown in FIG. 30;

FIG. 34 is a front view of the first restrain mechanism shown in FIG. 30;

FIG. 35 is a partial perspective view of an image forming apparatus according to certain embodiments of the present disclosure;

FIG. 36 is another perspective view of the image forming apparatus shown in FIG. 35;

FIG. 37 is a partial perspective view of an image forming apparatus according to certain embodiments of the present disclosure;

FIG. 38 is another partial perspective view of the image forming apparatus shown in FIG. 37;

FIG. 39 is a perspective view of the conductive member in FIG. 38;

FIG. 40 is a perspective view of a conductive cover for the cartridge in FIG. 37;

FIG. 41 is a perspective view of a cartridge with a conductive cover installed.

### Reference Numerals

100: adapter
110: first unlock mechanism
101: connect portion
102: protrude structure
103: abut face
104: slope face
105: Force-apply portion
121: first restrain mechanism
122: lock member
123: rod portion
124: first pressure-apply portion
125: first receive portion
126: connect member
127: second pressure-apply portion
128: second receive portion
129: slope receive face
130: second part
131: first part
132: first elastic element
133: second elastic element
135: protect cover
136: groove
137: connect post
138: notch
161: first drive source
162: body
163: frame
164: mate hole
166: third rotate member
170: mediator
171: first conductive contact
180: cartridge
181: first rotate member
182: housing
183: protrusion
184: deform member
185: end cap
186: second rotate member
187: outer surface
188: outer surface
190: front cover
191: linkage
192: protrusion

### DETAILED DESCRIPTION

In the following description, details are set forth in order to provide a more thorough understanding of the present disclosure. However, it will be apparent to those skilled in the technical field that the present disclosure may be practiced without one or more of these details. In other instances, certain technical features well-known in the technical field have not been described to avoid confusion with the present disclosure.

FIG. 1 is a partial structural schematic diagram of an image forming apparatus according to certain embodiments of the present disclosure. The image forming apparatus includes a body 162, and a cartridge 180 is detachably mounted inside the body 162. The cartridge 180 is connected to the body 162 and may receive the drive force output by the body 162, causing the cartridge 180 to operate and realize image forming. To ensure a normal connection between the cartridge 180 and the body 162, the present disclosure also provides an adapter 100, which may be installed on the cartridge 180 to prevent the compressive force of the drive source of the body 162 from damaging the cartridge 180.

The cartridge 180 includes a housing 182 and a first rotate member 181 arranged on the housing 182. The first rotate member 181 may be connected to the drum assembly. The cartridge 180 may be a toner cartridge. The first rotate member 181 may be configured as a drive head for a photosensitive unit. The housing 182 contains a developer, such as toner. The developer is uniformly adsorbed onto the film of the drum assembly by the action of a rotate shaft, forming an electrostatic latent image. For example, the first rotate member 181 may be configured as a gear set or a shaft. Rotation of the first rotate member 181 may drive the drum assembly to rotate, thereby allowing the developer to be uniformly coated onto the film.

To enable the first rotate member 181 to rotate, as shown in FIG. 6, the image forming apparatus body 162 further includes a first drive source 161, which is connected to the first rotate member 181 to drive the first rotate member 181 to rotate. The first drive source 161 may be configured as a drum assembly drive head. The first drive source 161 may drive the first rotate member 181 to rotate, thereby driving the drum assembly to rotate. The drum assembly drive head is connected to the drive head of the photosensitive unit to drive the drum assembly and ensure the normal operation of the toner cartridge. The first drive source 161 may be connected to the first rotate member 181 by means of teeth, threads, or keys. The rotation of the first drive source 161 may drive the first rotate member 181 to rotate.

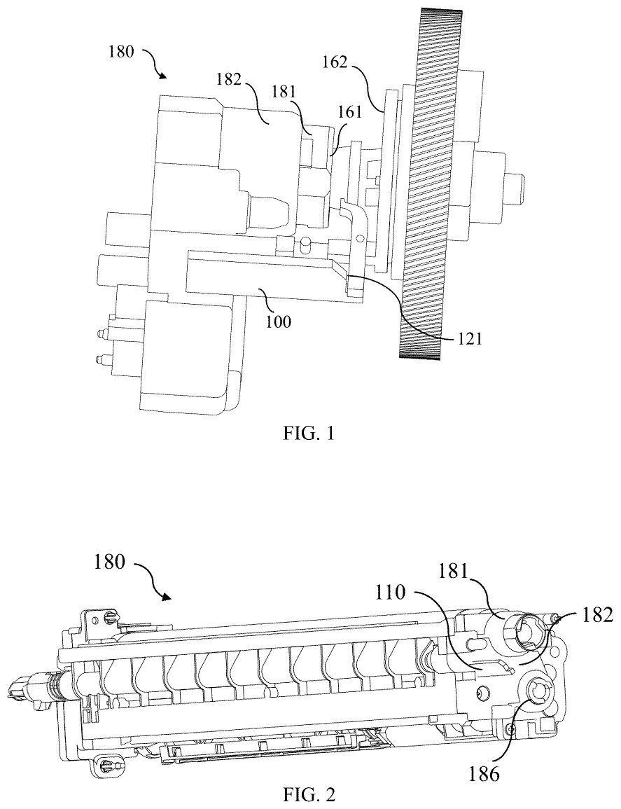

To enable the first rotate member 181 and the first drive source 161 to be connected, as shown in FIG. 2, the adapter 100 further includes a first unlock mechanism 110. The first unlock mechanism 110 is used to unlock the first drive source 161, allowing the first rotate member 181 to connect to the first drive source 161. The first unlock mechanism 110 may act as a push mechanism. The first unlock mechanism 110 may unlock the first drive source 161 by pushing.

When the cartridge 180 is assembled to the image forming apparatus body 162, the cartridge 180 moves toward the image forming apparatus body 162. The first unlock mechanism 110 moves toward the first drive source 161. After the first unlock mechanism 110 unlocks the first drive source 161, the first rotate member 181 is connected to the first drive source 161, so that the first drive source 161 drives the first rotate member 181 to rotate.

According to the adapter 100 of the present disclosure, the adapter 100 may be installed on the cartridge 180, the cartridge 180 includes a housing 182 and a first rotate member 181, the first rotate member 181 is arranged on the housing 182, and the adapter 100 includes a first unlock mechanism 110, the first unlock mechanism 110 is used to unlock the first drive source 161 so that the first rotate member 181 may be connected to the first drive source 161. In this way, reducing the operation force required to install the cartridge 180 may solve the problem of excessive operation force when installing the cartridge 180 into the image forming apparatus, or may solve the problem of direct hard impact between the first rotate member 181 and the first drive source 161 caused by excessive operation force, thus avoiding damage to the first rotate member 181 and the first drive source 161 caused by impact, ensuring that the first rotate member 181 and the first drive source 161 may be properly connected, and improving the reliability of the image forming apparatus.

In certain embodiments, the cartridge 180 further includes a second rotate member 186 arranged on the housing 182. The second rotate member 186 is configured as a drive member. The second rotate member 186 may be configured as a drive head for the first develop assembly. For example, the second rotate member 186 may be configured as a gear set or a shaft. Rotation of the second rotate member 186 may drive the develop assembly to rotate, thereby enabling the developer to be uniformly coated onto the film.

To enable the second rotate member to rotate, the image forming apparatus body 162 further includes a second drive source connected to the second rotate member to drive its rotation. The second drive source may be configured as a second develop assembly drive head. The second drive source may drive the second rotate member 186 to rotate, thereby driving the develop assembly to rotate. The second drive source may be connected to the second rotate member via a threaded or keyed connection. The rotation of the second drive source drives the second rotate member to rotate, ensuring the normal operation of the toner cartridge.

The cartridge 180 is detachably arranged on the image forming apparatus body 162. The cartridge 180 is detachably connected to the body 162. The first rotate member 181 is detachably connected to the body 162. The second rotate member 186 is detachably connected to the body 162. In certain embodiments, as shown in FIGS. 7 and 8, the first drive source 161 includes a third rotate member 166, which is located on the image forming apparatus body 162. The third rotate member 166 includes a drive structure such as a gear or shaft. The third rotate member 166 is connected to the first rotate member 181 so that the third rotate member 166 may drive the first rotate member 181 to rotate. The first rotate member 181 is used to mesh with the third rotate member 166. The size of the protrusion of the third rotate member 166 is clearance-fitted with the first rotate member 181, and the clearance size does not exceed 1 mm.

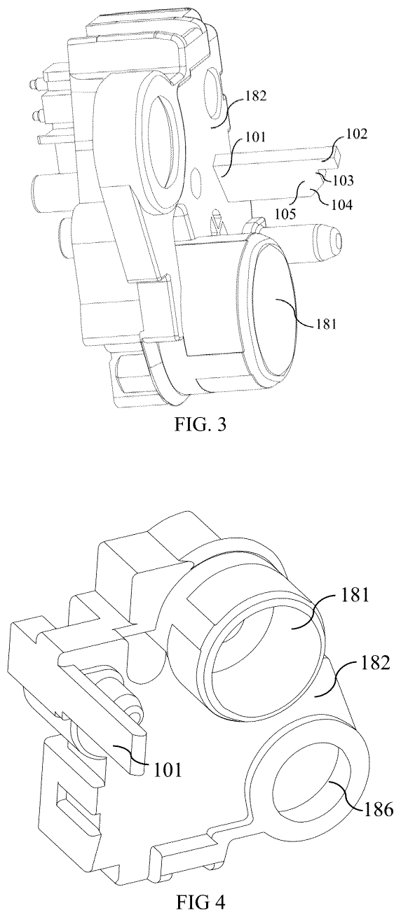

When the first unlock mechanism 110 is at a state of unlocking the first drive source 161, the first rotate member 181 engages with the third rotate member 166. As shown in FIG. 3, when the first rotate member 181 engages with the third rotate member 166, at least a portion of the first unlock mechanism 110 protrudes beyond the first rotate member 181 in the direction of its rotation axis. When the first rotate member 181 engages with the third rotate member 166, a portion of the first unlock mechanism 110 protrudes beyond the first rotate member 181 in the direction of its rotation axis. Therefore, a portion of the first unlock mechanism 110 protrudes beyond the first rotate member 181, preventing the first rotate member 181 from interfering with the first unlock mechanism 110. This also avoids increasing the design difficulty of the first rotate member 181 and the second rotate member 186 on the cartridge 180 due to space constraints. At the same time, it further ensures that the first unlock mechanism 110 may unlock the first drive source 161 normally, achieving engagement between the first rotate member 181 and the third rotate member 166 without separation, and ensuring the stable operation of the cartridge 180. This achieves the stability of maintaining image quality and the rationality of the miniaturized layout of the cartridge 180 structure.

When the first rotate member 181 engages with the third rotate member 166, the entire first unlock mechanism 110 protrudes beyond the first rotate member 181 along its rotation axis. This ensures that the first unlock mechanism 110 does not interfere with the first rotate member 181, avoids increased design complexity due to space constraints between the first rotate member 181 and the second rotate member 186 on the cartridge 180, and further guarantees that the first unlock mechanism 110 may normally unlock the first drive source 161. This achieves engagement between the first rotate member 181 and the third rotate member 166 without separation, and ensures stable operation of the cartridge 180, maintaining image quality stability and achieving a reasonable miniaturized layout of the cartridge 180.

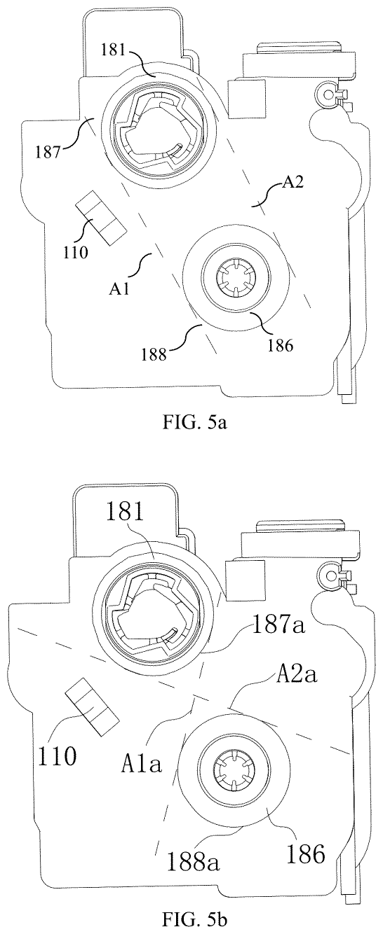

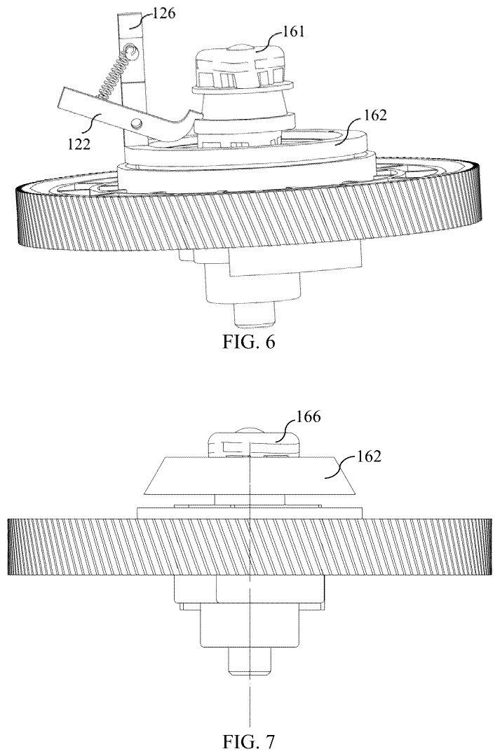

To ensure that the first unlock mechanism 110 may successfully unlock the first drive source 161, neither the first rotate member 181 nor the second rotate member 186 will interfere with the first unlock mechanism 110. The first rotate member 181 and the second rotate member 186 have a first common tangent A1 and a second common tangent A2. To distinguish them from other structures, as shown in FIG. 5a, the first common tangent A1 and the second common tangent A2 are shown as dashed lines, or as shown in FIG. 5b, the first common tangent A1a and the second common tangent A2a are shown as dashed lines. The first rotate member 181 is cylindrical. The axial direction of the first rotate member 181 is parallel to a movement direction of the first rotate member 181. The first rotate member 181 includes an outer surface 187 facing outwards. The outer surface of the first rotate member 181 refers to its outer peripheral surface. The first rotate member 181 also includes an inner surface facing inwards. The first rotate member 181 also includes a first hole for the first drive source 161 to enter. The inner surface of the first rotate member 181 forms the first hole. The inner surface of the first rotate member 181 refers to its inner peripheral surface.

The second rotate member 186 is cylindrical in shape. The axial direction of the second rotate member 186 is parallel to its movement direction. The second rotate member 186 includes an outer surface 188 facing outwards. The outer surface 188 refers to its outer peripheral surface. The second rotate member 186 also includes an inner surface facing inwards. The second rotate member 186 also includes a second hole for the entry of a second drive source. The inner surface of the second rotate member 186 forms the second hole. The inner surface of the second rotate member 186 refers to its inner peripheral surface.

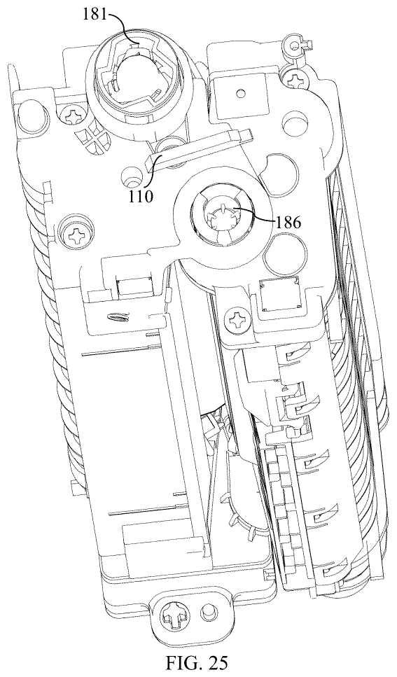

In certain embodiments shown in FIGS. 25 to 27, the adapter 100 is detachably arranged on the housing 182. The adapter 100 may also be rotatably and/or movably connected to the cartridge 180. Alternatively, the adapter 100 is rotatably connected to the cartridge 180. The adapter 100 is rotatably connected to the housing 182 of the cartridge 180. A first unlock mechanism 110 is rotatably connected to the cartridge 180. The first unlock mechanism 110 is rotatably connected to the housing 182 of the cartridge 180. For example, the adapter 100 may be connected to the cartridge 180 via a shaft. Adapter 100 is rotatable about an axis, thereby enabling it to be rotatably connected to cartridge 180. Adapter 100 may also be connected to housing 182 via an axis. Adapter 100 is rotatable about an axis, thereby enabling it to be rotatably connected to housing 182. Of course, adapter 100 may also be rotatably connected to cartridge 180 via other structures, the present disclosure does not further elaborate on this.

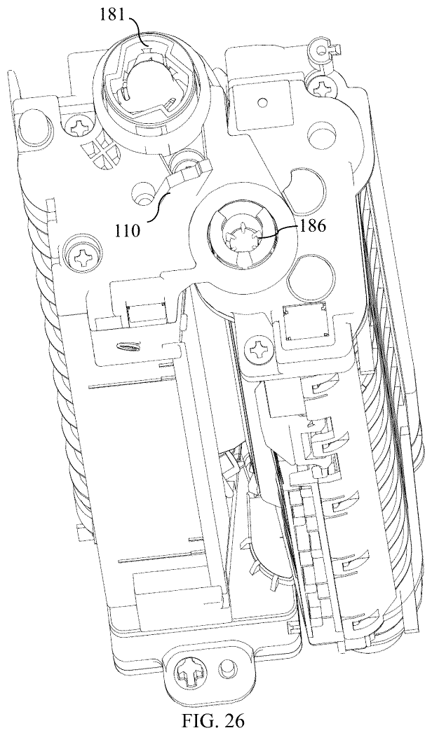

The first unlock mechanism 110 is detachably arranged on the housing 182. The first unlock mechanism 110 is movable relative to the housing 182. As shown in FIGS. 25 and 26, the first unlock mechanism 110 may be connected to the cartridge 180 via a shaft. The first unlock mechanism 110 may rotate about the shaft, thereby allowing the first unlock mechanism 110 to be rotatably connected to the cartridge 180. The first unlock mechanism 110 may also be rotatably connected to the housing 182 via a shaft. The first unlock mechanism 110 may rotate about the shaft, thereby allowing the first unlock mechanism 110 to be rotatably connected to the housing 182. Of course, the first unlock mechanism 110 may also be rotatably connected to the cartridge 180 via other structures, the present disclosure does not further elaborate on this.

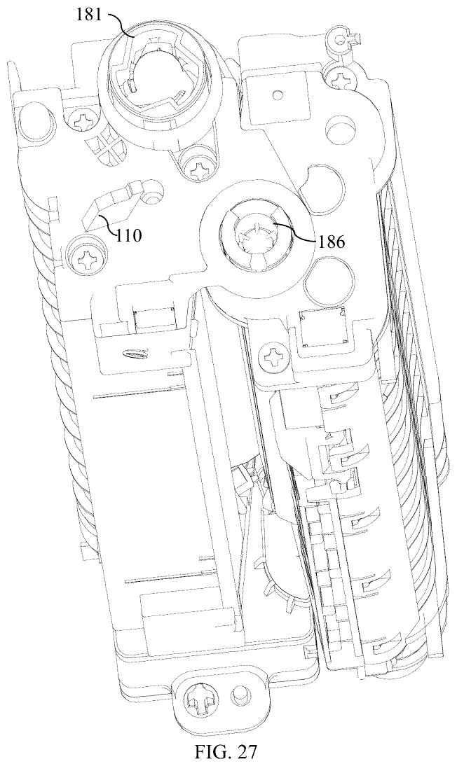

In certain embodiments, as shown in FIG. 27, adapter 100 is movably connected to cartridge 180. Adapter 100 is movably connected to housing 182 of cartridge 180. First unlock mechanism 110 is movably connected to cartridge 180. First unlock mechanism 110 is movably connected to housing 182 of cartridge 180. For example, adapter 100 may be connected to cartridge 180 via a slide rail. Adapter 100 may rotate about an axis, thereby enabling adapter 100 to be movably connected to cartridge 180. Adapter 100 may be connected to housing 182 via a slide rail. Adapter 100 may move along the slide rail, thereby enabling adapter 100 to be movably connected to housing 182. Of course, adapter 100 may also be movably connected to cartridge 180 via other structures, the present disclosure does not further elaborate on this.

The first unlock mechanism 110 may be connected to the cartridge 180 via a slide rail. The first unlock mechanism 110 may move along the slide rail, thus enabling it to be movably connected to the cartridge 180. The first unlock mechanism 110 may also be connected to the housing 182 via a slide rail. The first unlock mechanism 110 may move along the slide rail, thus enabling it to be movably connected to the housing 182. Of course, the first unlock mechanism 110 may also be movably connected to the cartridge 180 via other structures, the present disclosure does not further elaborate on this.

The first common tangent A1 is the outer common tangent of the first rotate member 181 and the second rotate member 186. The first common tangent A1 is tangent to the outer surface 187 of the first rotate member 181 and the outer surface 188 of the second rotate member 186. The second common tangent A2 is the outer common tangent of the first rotate member 181 and the second rotate member 186. The second common tangent A2 is tangent to the outer surface 187 of the first rotate member 181 and the outer surface 188 of the second rotate member 186. The first common tangent A1 and the second common tangent A2 are respectively located on opposite sides of the first rotate member 181. The first rotate member 181 is located between the first common tangent A1 and the second common tangent A2. The first common tangent A1 and the second common tangent A2 are respectively located on opposite sides of the second rotate member 186. The second rotate member 186 is located between the first common tangent A1 and the second common tangent A2.

An area is formed between the first common tangent A1 and the second common tangent A2, the first rotate member 181, and the second rotate member 186. A closed area is formed between the first common tangent A1, the second common tangent A2, the outer surface 187 of the first rotate member 181, and the outer surface 188 of the second rotate member 186.

When the first unlock mechanism 110 is at a state of unlocking the first drive source 161, at least a portion of the first unlock mechanism 110 is located outside the area formed between the first common tangent A1 and the second common tangent A2 and the first rotate member 181 and the second rotate member 186. When the first unlock mechanism 110 is at a state of unlocking the first drive source 161, a portion of the first unlock mechanism 110 is located outside the area formed between the first common tangent A1 and the second common tangent A2 and the first rotate member 181 and the second rotate member 186. Therefore, a portion of the first unlock mechanism 110 protrudes beyond the designated area, preventing the first rotate member 181 from interfering with the first unlock mechanism 110, and preventing the second rotate member 186 from interfering with the first unlock mechanism 110. This also avoids increased design complexity for the first rotate member 181 and the second rotate member 186 on the cartridge 180 due to space constraints. Simultaneously, it further ensures that a portion of the first unlock mechanism 110 may contact and unlock the first drive source 161, enabling the first unlock mechanism 110 to normally unlock the first drive source 161 and ensuring the stable operation of the cartridge 180. This achieves the stability of image quality and the rationality of the miniaturized layout of the cartridge 180 structure.

When the first unlock mechanism 110 is at a state of unlocking the first drive source 161, the entire first unlock mechanism 110 is located outside the area formed between the first common tangent A1 and the second common tangent A2 and the first rotate member 181 and the second rotate member 186. Therefore, the entire first unlock mechanism 110 protrudes outside the area, preventing the first rotate member 181 from interfering with the first unlock mechanism 110, preventing the second rotate member 186 from interfering with the first unlock mechanism 110, and also preventing the first rotate member 181 and the second rotate member 186 on the cartridge 180 from increasing design difficulty due to space constraints. Simultaneously, it further ensures that the entire first unlock mechanism 110 may contact and unlock the first drive source 161, enabling the first unlock mechanism 110 to normally unlock the first drive source 161 and ensuring the stable operation of the cartridge 180. This achieves the stability of image quality and the rationality of the miniaturized layout of the cartridge 180 structure.

In certain embodiments, the first common tangent A1a is the inner common tangent of the first rotate member 181 and the second rotate member 186. The first common tangent A1a is tangent to the surface 187a of the first rotate member 181 and the surface 188a of the second rotate member 186. The second common tangent A2a is the inner common tangent of the first rotate member 181 and the second rotate member 186. The second common tangent A2a is tangent to the surface 187a of the first rotate member 181 and the surface 188a of the second rotate member 186. The first common tangent A1a and the second common tangent A2a are respectively located on both sides of the first rotate member 181. The first rotate member 181 is located between the first common tangent A1a and the second common tangent A2a. The first common tangent A1a and the second common tangent A2a are respectively located on both sides of the second rotate member 186. The second rotate member 186 is located between the first common tangent A1a and the second common tangent A2a.

An area is formed between the first common tangent A1a and the second common tangent A2a and the first rotate member 181, and an area is formed between the first common tangent A1a and the second common tangent A2a and the second rotate member 186. A closed area is formed between the first common tangent A1a, the second common tangent A2a and the first rotate member 181, and a closed area is formed between the first common tangent A1a, the second common tangent A2a and the second rotate member 186. The first common tangent A1a and the second common tangent A2a are connected to the surface 187a of the first rotate member 181, and the first common tangent A1a and the second common tangent A2a are connected to the surface 188a of the second rotate member 186, thereby forming a closed area.

When the first unlock mechanism 110 is at a state of unlocking the first drive source 161, at least a portion of the first unlock mechanism 110 is located outside the area formed between the first common tangent A1a and the second common tangent A2a and the first rotate member 181, and outside the area formed between the first common tangent A1a and the second common tangent A2a and the first rotate member 181 and the second rotate member 186. When the first unlock mechanism 110 is at a state of unlocking the first drive source 161, a portion of the first unlock mechanism 110 is located outside the area formed between the first common tangent A1a and the second common tangent A2a and the first rotate member 181, and outside the area formed between the first common tangent A1a and the second common tangent A2a and the second rotate member 186. Therefore, a portion of the first unlock mechanism 110 protrudes beyond the area, preventing the first rotate member 181 from interfering with the first unlock mechanism 110 and preventing the second rotate member 186 from interfering with the first unlock mechanism 110. It also avoids increasing the design difficulty of the first rotate member 181 and the second rotate member 186 on the cartridge 180 due to the tight space layout. At the same time, it further ensures that a portion of the first unlock mechanism 110 may contact and unlock the first drive source 161, which may realize and ensure the stable operation of the cartridge 180, maintain the stability of the image quality, and achieve the rationality of the miniaturized layout of the cartridge 180 structure.

When the first unlock mechanism 110 is at a state of unlocking the first drive source 161, the entire first unlock mechanism 110 is located outside the area formed between the first common tangent A1a and the second common tangent A2a and the first rotate member 181, and outside the area formed between the first common tangent A1a and the second common tangent A2a and the second rotate member 186. Therefore, the entire first unlock mechanism 110 protrudes beyond the designated areas, avoiding increased design difficulty for the first rotate member 181 and the second rotate member 186 on the cartridge 180 due to space constraints. Simultaneously, it further ensures that the entire first unlock mechanism 110 may contact and unlock the first drive source 161, guaranteeing stable operation of the cartridge 180 and achieving the stability of maintaining image quality and the rationality of the miniaturized layout of the cartridge 180 structure.

To enable connection between the second rotate member 186 and the second drive source, the adapter 100 includes a second unlock mechanism for unlocking the second drive source, allowing the second rotate member 186 to connect to it. This enables the second drive source to drive the second rotate member 186 to rotate.

The second unlock mechanism is detachably arranged on the housing 182. The second unlock mechanism is movable relative to the housing 182. In certain embodiments, the second unlock mechanism may be connected to the cartridge 180 via a shaft. The second unlock mechanism may rotate about the shaft, thereby allowing the second unlock mechanism to be rotatably connected to the cartridge 180. Alternatively, the second unlock mechanism may also be rotatably connected to the cartridge 180 via other structures, the present disclosure does not further elaborate on this.

In certain embodiments, the second unlock mechanism may be connected to the cartridge 180 via a slide rail. The second unlock mechanism may move along the slide rail, thereby enabling it to be movably connected to the cartridge 180. The second unlock mechanism may also be connected to the housing 182 via a slide rail. The second unlock mechanism may move along the slide rail, thereby enabling it to be movably connected to the housing 182. Of course, the second unlock mechanism may also be movably connected to the cartridge 180 via other structures, the present disclosure does not further elaborate on this.

In certain embodiments, the adapter 100 may be rotatably connected to the cartridge 180 or movably connected to the cartridge 180. For example, the first unlock mechanism 110 is rotatably connected to the cartridge 180, and the second unlock mechanism is movably connected to the cartridge 180. Alternatively, the first unlock mechanism 110 is movably connected to the cartridge 180, and the second unlock mechanism is rotatably connected to the cartridge 180. Of course, the adapter 100 may include a greater number of unlock mechanisms to unlock a greater number of drive sources, and the cartridge 180 may include a greater number of rotate members, with the unlocked drive sources and rotate members connected together. The present disclosure does not impose restriction on this.

To ensure the second unlock mechanism may successfully unlock the second drive source, neither the first rotate member 181 nor the second rotate member 186 will interfere with the second unlock mechanism. When the second unlock mechanism is at a state of unlocking the second drive source, at least a portion of the second unlock mechanism is located outside the area formed between the first common tangent A1 and the second common tangent A2 and the first rotate member 181 and the second rotate member 186. When the second unlock mechanism is at a state of unlocking the second drive source, a portion of the second unlock mechanism is located outside the area formed between the first common tangent A1 and the second common tangent A2 and the first rotate member 181 and the second rotate member 186. Therefore, a portion of the second unlock mechanism protrudes beyond the area, preventing the first rotate member 181 from interfering with the second unlock mechanism, and preventing the second rotate member 186 from interfering with the second unlock mechanism. It also avoids increasing the design difficulty of the first rotate member 181 and the second rotate member 186 on the cartridge 180 due to the tight space layout. At the same time, it further ensures that a portion of the second unlock mechanism may contact and unlock the second drive source, so that the second unlock mechanism may unlock the second drive source normally, and ensures the stable operation of the cartridge 180. This achieves the stability of maintaining the image quality and the rationality of the miniaturized layout of the cartridge 180 structure.

To ensure the second unlock mechanism may successfully unlock the second drive source, neither the first rotate member 181 nor the second rotate member 186 will interfere with the second unlock mechanism. When the second unlock mechanism is at a state of unlocking the second drive source, at least a portion of the second unlock mechanism is located outside the area formed between the first common tangent A1a and the second common tangent A2a and the first rotate member 181, and outside the area formed between the first common tangent A1a and the second common tangent A2a and the second rotate member 186. When the second unlock mechanism is at a state of unlocking the second drive source, a portion of the second unlock mechanism is located outside the area formed between the first common tangent A1a and the second common tangent A2a and the first rotate member 181, and outside the area formed between the first common tangent A1a and the second common tangent A2a and the second rotate member 186. Therefore, a portion of the second unlock mechanism protrudes beyond the area, preventing the first rotate member 181 from interfering with the second unlock mechanism, and preventing the second rotate member 186 from interfering with the second unlock mechanism. It also avoids increasing the design difficulty of the first rotate member 181 and the second rotate member 186 on the cartridge 180 due to the tight space layout. At the same time, it further ensures that a portion of the second unlock mechanism may contact and unlock the second drive source, so that the second unlock mechanism may unlock the second drive source normally, and ensures the stable operation of the cartridge 180. This achieves the stability of maintaining the image quality and the rationality of the miniaturized layout of the cartridge 180 structure.

The first rotate member 181 also includes an end face facing the third rotate member 166. When the first unlock mechanism 110 is at a state of unlocking the first drive source 161, the first unlock mechanism 110 protrudes beyond the end face of the first rotate member 181. The second rotate member 186 also includes an end face facing the fourth rotate member. When the second unlock mechanism is at a state of unlocking the second drive source, the second unlock mechanism protrudes beyond the end face of the second rotate member 186.

When the second unlock mechanism is at a state of unlocking the second drive source, the entire second unlock mechanism is located outside the area formed between the first common tangent A1 and the second common tangent A2 and the first rotate member 181 and the second rotate member 186. Therefore, the entire second unlock mechanism protrudes beyond the area, preventing the first rotate member 181 from interfering with the second unlock mechanism, preventing the second rotate member 186 from interfering with the second unlock mechanism, and also preventing the first rotate member 181 and the second rotate member 186 on the cartridge 180 from increasing design difficulty due to space constraints. Simultaneously, it further ensures that the entire second unlock mechanism may contact and unlock the second drive source, enabling the second unlock mechanism to normally unlock the second drive source and ensuring the stable operation of the cartridge 180. This achieves the stability of image quality and the rationality of the miniaturized layout of the cartridge 180 structure.

When the second unlock mechanism is at a state of unlocking the second drive source, the entire second unlock mechanism is located outside the area formed between the first common tangent A1a and the second common tangent A2a and the first rotate member 181, and outside the area formed between the first common tangent A1a and the second common tangent A2a and the second rotate member 186. Thus, the entire second unlock mechanism protrudes beyond the designated areas, preventing the first rotate member 181 from interfering with the second unlock mechanism, preventing the second rotate member 186 from interfering with the second unlock mechanism, and also preventing the first rotate member 181 and the second rotate member 186 on the cartridge 180 from increasing design difficulty due to space constraints. Simultaneously, it further ensures that the entire second unlock mechanism may contact and unlock the second drive source, enabling the second unlock mechanism to normally unlock the second drive source and ensuring the stable operation of the cartridge 180. This achieves the stability of image quality and the rationality of the miniaturized layout of the cartridge 180 structure.

In certain embodiments, the second drive source includes a fourth rotate member located on the image forming apparatus body 162. The fourth rotate member includes a drive structure such as a gear or shaft, and is connected to the second rotate member 186 so that the fourth rotate member may drive the second rotate member 186 to rotate. The second rotate member 186 is used to engage with the fourth rotate member.

When the second unlock mechanism is at a state of unlocking the second drive source, the second rotate member 186 engages with the fourth rotate member. When the second rotate member 186 engages with the fourth rotate member, at least a portion of the second unlock mechanism protrudes beyond the second rotate member 186 in the direction of its rotation axis. When the second rotate member 186 engages with the fourth rotate member, a portion of the second unlock mechanism protrudes beyond the second rotate member 186 in the direction of its rotation axis. Therefore, a portion of the second unlock mechanism protrudes beyond the second rotate member 186, preventing the second rotate member 186 from interfering with the second unlock mechanism. This also avoids increasing the design difficulty of the first rotate member 181 and the second rotate member 186 on the cartridge 180 due to space constraints. At the same time, it further ensures that the second unlock mechanism may unlock the second drive source normally, enabling the second rotate member 186 to engage with the fourth rotate member without separation, and ensuring the stable operation of the cartridge 180. This achieves the stability of maintaining image quality and the rationality of the miniaturized layout of the cartridge 180 structure.

When the second rotate member 186 engages with the fourth rotate member, the entire second unlock mechanism protrudes beyond the second rotate member 186 along its rotation axis. This ensures that the second unlock mechanism does not interfere with the second rotate member 186, avoids increased design complexity due to space constraints between the first rotate member 181 and the second rotate member 186 on the cartridge 180, and further guarantees that the second unlock mechanism may normally unlock the second drive source. This allows the second rotate member 186 to engage with the fourth rotate member without separation, ensures stable operation of the cartridge 180, maintains stable image quality, and achieves a reasonable miniaturized layout for the cartridge 180.

The first unlock mechanism 110 is movable relative to the cartridge 180. In certain embodiments, the first unlock mechanism 110 is movable between the inside and outside of the area formed between the first common tangent A1 and the second common tangent A2 and the first rotate member 181 and the second rotate member 186.

The first unlock mechanism 110 is movable relative to the cartridge 180. In particular, the first unlock mechanism 110 is movable between the inside and outside of the area formed between the first common tangent A1a and the second common tangent A2a and the first rotate member 181, and between the inside and outside of the area formed between the first common tangent A1a and the second common tangent A2a and the second rotate member 186.

The first unlock mechanism 110, located inside the area, may rotate to the outside of the area. Alternatively, the first unlock mechanism 110, located inside the area, may move to the outside of the area. The first unlock mechanism 110, located inside the area, may be received within the area. For example, the first unlock mechanism 110, located inside the area, may be foldably received within the area. The first unlock mechanism 110, located inside the area, does not protrude beyond the first rotate member 181. The first unlock mechanism 110, located outside the area, may unlock the first drive source 161.

In certain embodiments shown in FIG. 4, the adapter 100 may also be fixed to the cartridge 180. The adapter 100 may be integrally formed with the cartridge 180. The adapter 100 is integrally formed with the housing 182 of the cartridge 180. The adapter 100 may also be connected to the cartridge 180 by injection molding. The first unlock mechanism 110 is located to the side of the first rotate member 181. The first unlock mechanism 110 is integrally formed with the housing 182. The first unlock mechanism 110 is fixed relative to the housing 182. The second unlock mechanism is located to the side of the second rotate member 186. The second unlock mechanism is integrally formed with the housing 182. The second unlock mechanism is fixed relative to the housing 182. Thus, good connection strength between the adapter 100 and the cartridge 180 is ensured.

In certain embodiments, multiple cartridges 180 may be respectively arranged to the image forming apparatus body 162. Each cartridge includes at least one develop assembly, which is arranged to the image forming apparatus body 162 via the housing 182 of its respective cartridge 180. The developers in the multiple cartridges 180 are of different colors; the developers described herein may be toner. This allows for the generation of patterns of different colors. When multiple cartridges 180 are respectively arranged to the image forming apparatus body 162, cartridges 180 containing different colors may be installed in the wrong position. Therefore, adapters of different sizes are installed on the cartridges 180 containing different colors of developers, or adapters of different sizes are installed at different positions on the cartridges 180 containing different colors of developers, to prevent users from installing cartridges 180 containing different colors of developers in the wrong position when installing them to the image forming apparatus body 162, thus preventing issues with print quality.

The more detailed structure of the first unlock mechanism 110 will now be described.

As shown in FIG. 3, the first unlock mechanism 110 includes a connect portion 101 and a force-apply portion 105, which are connected to each other. The connect portion 101 and the force-apply portion 105 are connected along the movement direction of the first unlock mechanism 110. The connect portion 101 is closer to the housing 182 in comparison to the force-apply portion 105. The connect portion 101 includes a first connect end and a second connect end, located at opposite ends of the connect portion 101 along the movement direction of the first unlock mechanism 110. The first connect end is used to fix it to the housing 182. In certain embodiments, the first unlock mechanism 110 further includes a reinforce rib located at the connection between the first connect end and the housing 182. The reinforce rib enhances the connection strength between the first connect end and the housing 182.

The first connect end is used for detachable connection to the cartridge 180. The first connect end may be connected to the housing 182 by plugging it in. The connect portion 101 may be constructed as a plate-like structure. The housing 182 may be provided with a groove, into which the connect portion 101 may be inserted.

The second connect end is used to connect the force-apply portion 105. The force-apply portion 105 is closer to the first drive source 161 in comparison to the connect portion 101. The force-apply portion 105 is used to unlock the first drive source 161. In order for the force-apply portion 105 to unlock the first drive source 161, the force-apply portion 105 includes an abut face 103. The force-apply portion 105 abuts against the mate structure of the first drive source 161 through the abut face 103 to unlock the first drive source 161. The abut face 103 contacts the mate structure. The force-apply portion 105 applies a force to the mate structure through the abut face 103. The force-apply portion 105 may unlock the mate structure to unlock the first drive source 161. The first drive source 161 is unlocked, thereby protruding towards the cartridge 180, thereby connecting the first drive source 161 and the first connect member.

To ensure that the force-apply portion 105 may accurately unlock the first drive source 161, the force-apply portion 105 also includes a protrude structure 102, which protrudes beyond the abut face 103. The protrude structure 102 protrudes towards the first drive source 161. The protrude structure 102 protrudes beyond the connect portion 101 towards the first drive source 161. The protrude structure 102 protrudes beyond the second connect end of the connect portion 101 towards the first drive source 161. The protrude structure 102 and the abut face 103 may be constructed as one unit. The abut face 103 of the protrude structure 102 may contact the mate structure. The protrude structure 102 applies force to the mate structure through the abut face 103 to unlock the first drive source 161.

The protrude structure 102 and the abut face 103 may also be configured as separate structures. In certain embodiments, the protrude structure 102 is located to the side of the mate structure of the first drive source 161. The abut face 103 is located at the second connect end of the connect portion 101. The abut face 103 may contact the mate structure. The connect portion 101 applies force to the mate structure through the abut face 103 to unlock the first drive source 161. The protrude structure 102 is located to the side of the abut face 103. The protrude structure 102 may be located to the side of the abut face 103 in a direction perpendicular to the movement direction of the first unlock mechanism 110. The protrude structure 102 is located to the side of the first drive source 161. Thus, the protrude structure 102 may play a position-limit role, so that the abut face 103 remains in contact with the mate structure.

To ensure smooth contact between the abut face 103 and the mate structure, the connect portion 101 further includes a slope face 104, located at the end away from the protrude structure 102. The slope face 104 is located at the second connect end of the connect portion 101. The slope face 104 is located at the end of the second connect end of the connect portion 101 away from the protrude structure 102. The slope face 104 is connected to the abut face 103. The slope face 104 is inclined outward from the abut face 103 towards the housing 182. The included angle between the slope face 104 and the abut face 103 may be greater than 180°. Therefore, the slope face 104 may guide the contact between the first unlock mechanism 110 and the first drive source 161. In particular, the slope face 104 may guide the contact between the abut face 103 and the mate structure.

In certain embodiments, the force-apply portion 105 and the connect portion 101 are integrally formed. The force-apply portion 105 and the connect portion 101 may be constructed as an integral unit. The first unlock mechanism 110 is constructed as an integral unit. Thus, it has good structural strength. In certain embodiments, the force-apply portion 105 is detachably arranged on the connect portion 101. The force-apply portion 105 may be arranged on the connect portion 101 by bolts or other connect members. The force-apply portion 105 is configured as a force-applying member that applies force to the first drive source 161, and the force-apply portion 105 may be removed from the connect portion 101 for easy maintenance.

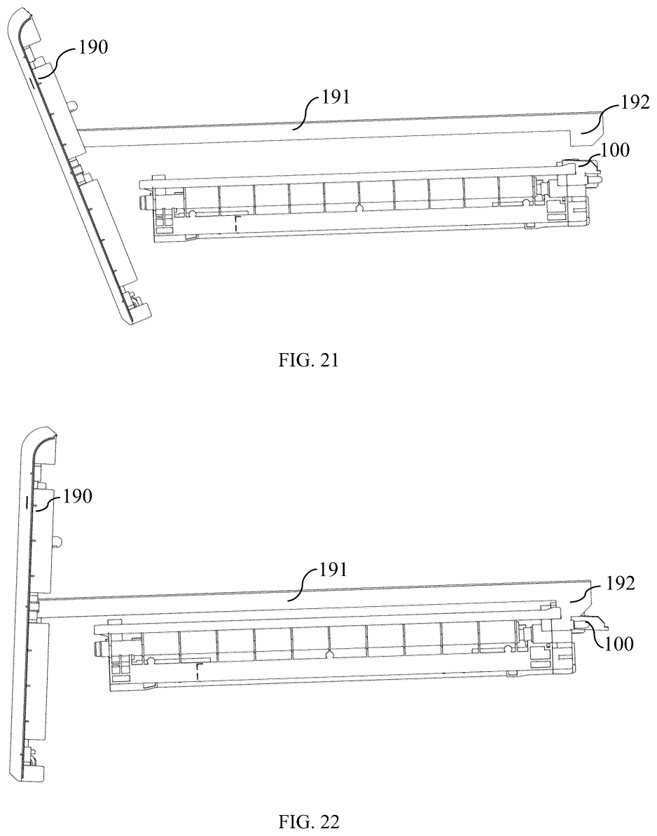

In certain embodiments, the adapter 100 may be retracted into the cartridge 180. After the cartridge 180 is arranged, the adapter 100 may also extend out of the cartridge 180. In the embodiments shown in FIGS. 21 and 22, the image forming apparatus further includes a front cover 190, which may unlock the first unlock mechanism 110. As shown in FIG. 21, the first unlock mechanism 110 may be arranged inside the housing 182 of the cartridge 180. The first unlock mechanism 110 is retracted into the cartridge 180. When the cartridge 180 is arranged on the image forming apparatus body 162 and the front cover 190 of the image forming apparatus is not closed, the linkage 191 does not interact with the first unlock mechanism 110. The first unlock mechanism 110 is at a retract state. As shown in FIG. 22, when the front cover 190 of the image forming apparatus is closed, the protrusion 192 of the linkage 191 on the front cover 190 acts on the first unlock mechanism 110. For example, the linkage 191 presses down on the first unlock mechanism 110. Under the action of the linkage 191 on the front cover 190, after the first unlock mechanism 110 inside the housing 182 of the cartridge 180 extends out of the housing 182, the first unlock mechanism 110 then extends into the frame 163 of the image forming apparatus to unlock the first restrain mechanism 121.

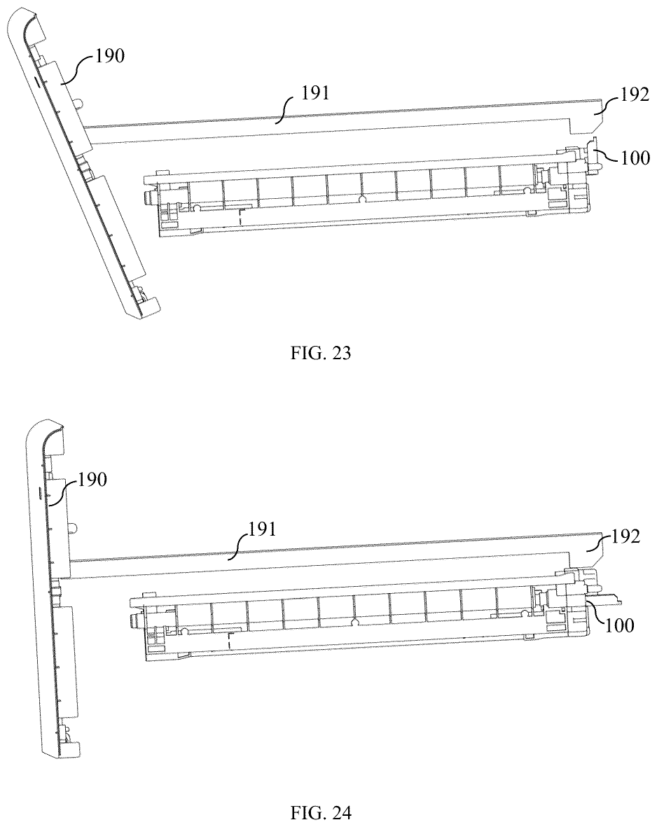

As shown in FIGS. 23 and 24, the image forming apparatus further includes a front cover 190 capable of unlocking the first unlock mechanism 110. As shown in FIG. 23, the first unlock mechanism 110 is folded into the frame 163 of the housing 182 of the cartridge 180. When the cartridge 180 is arranged onto the image forming apparatus body 162, as shown in FIG. 24, when the front cover 190 is closed, the protrusion 192 of the linkage 191 presses down on the first unlock mechanism 110, causing the first unlock mechanism 110 to rotate. After the first unlock mechanism 110 rotates out of the housing 182, it then extends back into the frame 163 of the image forming apparatus to unlock the first restrain mechanism 121.

The present disclosure in certain embodiments also provides a cartridge 180, which includes a housing 182, and the housing 182 includes a installation area. The installation area is used to install the adapter 100 described herein.

According to the cartridge 180 of certain embodiments of the present disclosure, the cartridge 180 includes a housing 182, the housing 182 including a installation area for installing the adapter 100. The cartridge 180 includes the housing 182 and a first rotate member 181, the first rotate member 181 being arranged on the housing 182. The adapter 100 includes a first unlock mechanism 110, the first unlock mechanism 110 being used to unlock the first drive source 161, so that the first rotate member 181 may connect to the first drive source 161. This reduces the operation force required to install the cartridge 180, solving the problem of excessive operation force when installing the cartridge 180 into the image forming apparatus, or preventing direct hard impact between the first rotate member 181 and the first drive source 161 due to excessive operation force, avoiding damage to the first rotate member 181 and the first drive source 161 due to impact, ensuring normal connection between the first rotate member 181 and the first drive source 161, and improving the reliability of the image forming apparatus.

The installation area faces the image forming apparatus body 162. The adapter 100 is connected to the installation area. The adapter 100 may be connected to the installation area. The adapter 100 may also be detachably connected to the installation area.

As shown in FIG. 2, the cartridge 180 further includes a first rotate member 181, which is arranged on the housing 182. An installation area is arranged near the first rotate member 181. The installation area is located to the side of the first rotate member 181. The adapter 100 is arranged to the area to the side of the first rotate member 181. The cartridge 180 also includes a second rotate member 186, which is arranged on the housing 182. The installation area may also be arranged near the second rotate member 186. The installation area is located to the side of the second rotate member 186. The adapter 100 is arranged to the area to the side of the second rotate member 186. The installation area may include the area between the first rotate member 181 and the second rotate member 186. The installation area may further include the area enclosed by the first common tangent A1, the second common tangent A2, the first rotate member 181, and the second rotate member 186. The installation area may also include the area outside the area enclosed by the first common tangent A1, the second common tangent A2, the first rotate member 181, and the second rotate member 186. In certain embodiments, the installation area may also include the area enclosed by the first common tangent A1a, the second common tangent A2a, and the first rotate member 181, and the area enclosed by the first common tangent A1a, the second common tangent A2a, and the second rotate member 186. The installation area may also include the area outside the area enclosed by the first common tangent A1a, the second common tangent A2a, and the first rotate member 181, and the area outside the area enclosed by the first common tangent A1a, the second common tangent A2a, and the second rotate member 186.

Adapter 100 includes a first unlock mechanism 110, which is arranged to the installation area. The first unlock mechanism 110 may be fixed to the housing 182 of the installation area. The first unlock mechanism 110 may also be detachably arranged to the housing 182 of the installation area. This avoids interference between the first unlock mechanism 110 and other structures of the cartridge 180. Adapter 100 also includes a second unlock mechanism, which is arranged to the installation area. The second unlock mechanism may be fixed to the housing 182 of the installation area. The second unlock mechanism may also be detachably arranged to the housing 182 of the installation area. This avoids interference between the second unlock mechanism and other structures of the cartridge 180. Of course, the adapter 100 may also include a greater number of unlock mechanisms, each arranged in the installation area to avoid interference with other structures of the cartridge 180. This also prevents the first rotate member 181 and the second rotate member 186 on the cartridge 180 from having increased design complexity due to space constraints. Furthermore, it ensures that the unlock mechanisms may properly unlock the drive source and guarantee the stable operation of the cartridge 180, thus maintaining image quality stability and achieving a reasonable miniaturized layout of the cartridge 180.

Furthermore, the first rotate member 181, the second rotate member 186, the first unlock mechanism 110, and the second unlock mechanism all protrude beyond the surface of the housing 182. The first rotate member 181 is the drive head of the photosensitive drum, and the second rotate member 186 is the drive head of the develop assembly. This ensures that the unlock mechanism may unlock the drive source normally and ensures the stable operation of the cartridge 180, thereby achieving the stability of image quality and the rationality of the miniaturized layout of the cartridge 180.

The present disclosure in certain embodiments also provides a cartridge 180, which includes a housing 182, a first rotate member 181, and a first unlock mechanism 110. The first rotate member 181 is arranged on the housing 182. The first rotate member 181 is rotatable relative to the housing 182. The first unlock mechanism 110 is used to unlock a first drive source 161, so that the first rotate member 181 may be connected to the first drive source 161.

The housing 182 contains a developer, such as toner. The developer is uniformly adsorbed onto the film of the drum assembly by the action of a rotate shaft, forming an electrostatic latent image. For example, the first rotate member 181 may be constructed as a gear set or a shaft. The rotation of the first rotate member 181 may drive the develop assembly to rotate, thereby allowing the developer to be uniformly coated onto the film.

To enable the first rotate member 181 to rotate, the image forming apparatus body 162 further includes a first drive source 161, which is connected to the first rotate member 181 to drive the first rotate member 181 to rotate. The first drive source 161 may be connected to the first rotate member 181 by way of teeth, threads, or keys. Rotation of the first drive source 161 may drive the first rotate member 181 to rotate. To enable the first rotate member 181 and the first drive source 161 to be connected, a first unlock mechanism 110 is used to unlock the first drive source 161, allowing the first rotate member 181 to be connected to the first drive source 161. Thus, the first drive source 161 may drive the first rotate member 181 to rotate.

When the cartridge 180 is assembled to the image forming apparatus body 162, the cartridge 180 moves toward the image forming apparatus body 162. The first unlock mechanism 110 moves toward the first drive source 161. After the first unlock mechanism 110 unlocks the first drive source 161, the first rotate member 181 is connected to the first drive source 161, so that the first drive source 161 drives the first rotate member 181 to rotate.

According to the cartridge 180 of the present disclosure, the cartridge 180 includes a housing 182, a first rotate member 181, and a first unlock mechanism 110. The first rotate member 181 is arranged on the housing 182, and the first unlock mechanism 110 is used to unlock the first drive source 161 so that the first rotate member 181 may be connected to the first drive source 161. In this way, the operation force for installing the cartridge 180 is reduced, which may solve the problem of excessive operation force when installing the cartridge 180 into the image forming apparatus, or may solve the problem of direct hard impact between the first rotate member 181 and the first drive source 161 due to excessive operation force, avoid the problem of damage to the first rotate member 181 and the first drive source 161 due to impact, ensure that the first rotate member 181 and the first drive source 161 may be properly connected, and improve the reliability of the image forming apparatus.

In certain embodiments, the cartridge 180 further includes a second rotate member 186 arranged on the housing 182. The second rotate member 186 is configured as a drive member. For example, the second rotate member 186 may be configured as a gear set or a shaft. Rotation of the second rotate member may drive the developing member to rotate, thereby enabling the developer to be uniformly coated onto the film.

To enable the second rotate member 186 to rotate, the image forming apparatus body 162 further includes a second drive source connected to the second rotate member 186 to drive the second rotate member 186 to rotate. The second drive source may be connected to the second rotate member 186 by way of a thread or a key. Rotation of the second drive source may drive the second rotate member 186 to rotate.

To ensure that the first unlock mechanism 110 may successfully unlock the first drive source 161, neither the first rotate member 181 nor the second rotate member 186 will interfere with the first unlock mechanism 110. The first rotate member 181 and the second rotate member 186 have a first common tangent A1 and a second common tangent A2. The first rotate member 181 is cylindrical. The axial direction of the first rotate member 181 is parallel to its movement direction. The first rotate member 181 includes an outer surface, and the outer surface 187 of the first rotate member 181 faces the outside of the first rotate member 181. The outer surface 187 of the first rotate member 181 refers to its outer peripheral surface. The first rotate member 181 also includes an inner surface, which faces inwards. The first rotate member 181 also includes a first hole for the first drive source 161 to enter. The inner surface of the first rotate member 181 forms the first hole. The inner surface of the first rotate member 181 refers to its inner peripheral surface.

To ensure that the first unlock mechanism 110 may successfully unlock the first drive source 161, neither the first rotate member 181 nor the second rotate member 186 will interfere with the first unlock mechanism 110. The first rotate member 181 and the second rotate member 186 have a first common tangent A1a and a second common tangent A2a. The first rotate member 181 is cylindrical. The axial direction of the first rotate member 181 is parallel to its direction of movement. The first rotate member 181 includes an outer surface, and the outer surface 187a of the first rotate member 181 faces the outside of the first rotate member 181. The outer surface 187a of the first rotate member 181 refers to its outer peripheral surface. The first rotate member 181 also includes an inner surface, which faces inwards. The first rotate member 181 also includes a first hole for the first drive source 161 to enter. The inner surface of the first rotate member 181 forms the first hole. The inner surface of the first rotate member 181 refers to its inner peripheral surface.

The second rotate member 186 is cylindrical in shape. The axial direction of the second rotate member 186 is parallel to its movement direction. The second rotate member 186 includes an outer surface 188 facing outwards. The outer surface 188 refers to its outer peripheral surface. The second rotate member 186 also includes an inner surface facing inwards. The second rotate member 186 also includes a second hole for the entry of a second drive source. The inner surface of the second rotate member 186 forms the second hole. The inner surface of the second rotate member 186 refers to its inner peripheral surface.

The second rotate member 186 is cylindrical in shape. The axial direction of the second rotate member 186 is parallel to its movement direction. The second rotate member 186 includes an outer surface 188a facing outwards. The outer surface 188a refers to the outer peripheral surface. The second rotate member 186 also includes an inner surface facing inwards. The second rotate member 186 also includes a second hole for a second drive source to enter. The inner surface of the second rotate member 186 forms the second hole. The inner surface of the second rotate member 186 refers to the inner peripheral surface.

The first unlock mechanism 110 may also be rotatably and/or movably connected to the cartridge 180. The second unlock mechanism may also be rotatably and/or movably connected to the cartridge 180.

In certain embodiments, the first unlock mechanism 110 is rotatably connected to the cartridge 180. The first unlock mechanism 110 is rotatably connected to the housing 182 of the cartridge 180. The first unlock mechanism 110 is detachably arranged on the housing 182. The first unlock mechanism 110 is movable relative to the housing 182. As shown in FIGS. 25 and 26, the first unlock mechanism 110 may be connected to the cartridge 180 via a shaft. The first unlock mechanism 110 may rotate about the shaft, thereby enabling the first unlock mechanism 110 to be rotatably connected to the cartridge 180. The first unlock mechanism 110 may also be connected to the housing 182 via a shaft. The first unlock mechanism 110 may rotate about the shaft, thereby enabling the first unlock mechanism 110 to be rotatably connected to the housing 182. Of course, the first unlock mechanism 110 may also be rotatably connected to the cartridge 180 via other structures, the present disclosure does not further elaborate on this.

In certain embodiments, as shown in FIG. 27, the first unlock mechanism 110 is movably connected to the cartridge 180. The first unlock mechanism 110 is also movably connected to the housing 182 of the cartridge 180. For example, the first unlock mechanism 110 may be connected to the cartridge 180 via a slide rail. The first unlock mechanism 110 may move along the slide rail, thereby enabling the first unlock mechanism 110 to be movably connected to the cartridge 180. The first unlock mechanism 110 may also be connected to the housing 182 via a slide rail. The first unlock mechanism 110 may move along the slide rail, thereby enabling the first unlock mechanism 110 to be movably connected to the housing 182. Of course, the first unlock mechanism 110 may also be movably connected to the cartridge 180 via other structures, the present disclosure does not further elaborate on this.

The first common tangent A1 is the outer common tangent of the first rotate member 181 and the second rotate member 186. The first common tangent A1 is tangent to the outer surface 187 of the first rotate member 181 and the outer surface 188 of the second rotate member 186. The second common tangent A2 is the outer common tangent of the first rotate member 181 and the second rotate member 186. The second common tangent A2 is tangent to the outer surface 187 of the first rotate member 181 and the outer surface 188 of the second rotate member 186. The first common tangent A1 and the second common tangent A2 are respectively located on both sides of the first rotate member 181. The first rotate member 181 is located between the first common tangent A1 and the second common tangent A2. The first common tangent A1 and the second common tangent A2 are respectively located on both sides of the second rotate member 186. The second rotate member 186 is located between the first common tangent A1 and the second common tangent A2.

An area is formed between the first common tangent A1 and the second common tangent A2 and the first rotate member 181 and the second rotate member 186. A closed area is formed between the first common tangent A1, the second common tangent A2, the first rotate member 181, and the second rotate member 186. The first common tangent A1, the second common tangent A2, the outer surface 187 of the first rotate member 181, and the outer surface 188 of the second rotate member 186 are connected to form a closed area. When the first unlock mechanism 110 is at a state of unlocking the first drive source 161, at least a portion of the first unlock mechanism 110 is located outside the area formed between the first common tangent A1 and the second common tangent A2 and the first rotate member 181 and the second rotate member 186. When the first unlock mechanism 110 is at a state of unlocking the first drive source 161, a portion of the first unlock mechanism 110 is located outside the area formed between the first common tangent A1 and the second common tangent A2 and the first rotate member 181 and the second rotate member 186. Thus, a portion of the first unlock mechanism 110 protrudes beyond the area, preventing the first rotate member 181 from interfering with the first unlock mechanism 110, preventing the second rotate member 186 from interfering with the first unlock mechanism 110, and also preventing the first rotate member 181 and the second rotate member 186 on the cartridge 180 from increasing design difficulty due to space constraints. Simultaneously, it further ensures that a portion of the first unlock mechanism 110 may contact and unlock the first drive source 161, enabling the first unlock mechanism 110 to normally unlock the first drive source 161, ensuring the stable operation of the cartridge 180, maintaining the stability of image quality, and achieving the rationality of the miniaturized layout of the cartridge 180 structure.

When the first unlock mechanism 110 is at a state of unlocking the first drive source 161, the entire first unlock mechanism 110 is located outside the area formed between the first common tangent A1 and the second common tangent A2 and the first rotate member 181 and the second rotate member 186. Therefore, the entire first unlock mechanism 110 protrudes beyond the area, preventing the first rotate member 181 from interfering with the first unlock mechanism 110, preventing the second rotate member 186 from interfering with the first unlock mechanism 110, and also preventing the first rotate member 181 and the second rotate member 186 on the cartridge 180 from increasing design difficulty due to space constraints. Simultaneously, it further ensures that the entire first unlock mechanism 110 may contact and unlock the first drive source 161, enabling the first unlock mechanism 110 to normally unlock the first drive source 161, ensuring the stable operation of the cartridge 180, maintaining the stability of image quality, and achieving the rationality of the miniaturized layout of the cartridge 180 structure.

The first common tangent A1a is the inner common tangent of the first rotate member 181 and the second rotate member 186. The first common tangent A1a is tangent to the outer surface 187a of the first rotate member 181 and the outer surface 188a of the second rotate member 186. The second common tangent A2a is the inner common tangent of the first rotate member 181 and the second rotate member 186. The second common tangent A2a is tangent to the outer surface 187a of the first rotate member 181 and the outer surface 188a of the second rotate member 186. The first common tangent A1a and the second common tangent A2a are respectively located on opposite sides of the first rotate member 181. The first rotate member 181 is located between the first common tangent A1a and the second common tangent A2a. The first common tangent A1a and the second common tangent A2a are respectively located on opposite sides of the second rotate member 186. The second rotate member 186 is located between the first common tangent A1a and the second common tangent A2a.

An area is formed between the first common tangent A1a and the second common tangent A2a and the first rotate member 181, and an area is formed between the first common tangent A1a and the second common tangent A2a and the second rotate member 186. A closed area is formed between the first common tangent A1a and the second common tangent A2a and the first rotate member 181, and a closed area is formed between the first common tangent A1a and the second common tangent A2a and the second rotate member 186. The first common tangent A1a and the second common tangent A2a are connected to the outer surface 187a of the first rotate member 181, and the first common tangent A1a and the second common tangent A2a are connected to the outer surface 188a of the second rotate member 186, thereby forming a closed area.

When the first unlock mechanism 110 is at a state of unlocking the first drive source 161, at least a portion of the first unlock mechanism 110 is located outside the area formed between the first common tangent A1a and the second common tangent A2a and the first rotate member 181, and outside the area formed between the first common tangent A1a and the second common tangent A2a and the second rotate member 186. When the first unlock mechanism 110 is at a state of unlocking the first drive source 161, a portion of the first unlock mechanism 110 is located outside the area formed between the first common tangent A1a and the second common tangent A2a and the first rotate member 181, and outside the area formed between the first common tangent A1a and the second common tangent A2a and the second rotate member 186. Therefore, a portion of the first unlock mechanism 110 protrudes beyond the area, preventing the first rotate member 181 from interfering with the first unlock mechanism 110 and the second rotate member 186 from interfering with the first unlock mechanism 110. It also avoids increasing the design difficulty of the first rotate member 181 and the second rotate member 186 on the cartridge 180 due to the tight space layout. At the same time, it further ensures that a portion of the first unlock mechanism 110 may contact and unlock the first drive source 161, so that the first unlock mechanism 110 may normally unlock the first drive source 161 and ensure the stable operation of the cartridge 180. This achieves the stability of maintaining the image quality and the rationality of the miniaturized layout of the cartridge 180 structure.

When the first unlock mechanism 110 is at a state of unlocking the first drive source 161, the entire first unlock mechanism 110 is located outside the area formed between the first common tangent A1a and the second common tangent A2a and the first rotate member 181, and outside the area formed between the first common tangent A1a and the second common tangent A2a and the second rotate member 186. Therefore, the entire first unlock mechanism 110 protrudes beyond the designated areas, preventing the first rotate member 181 from interfering with the first unlock mechanism 110, preventing the second rotate member 186 from interfering with the first unlock mechanism 110, and also avoiding increased design difficulty for the first rotate member 181 and the second rotate member 186 on the cartridge 180 due to space constraints. Simultaneously, it further ensures that the entire first unlock mechanism 110 may contact and unlock the first drive source 161, enabling the first unlock mechanism 110 to normally unlock the first drive source 161, ensuring the stable operation of the cartridge 180, maintaining the stability of image quality, and achieving the rationality of the miniaturized layout of the cartridge 180 structure.

To enable the second rotate member 186 to connect with the second drive source, the cartridge 180 includes a second unlock mechanism for unlocking the second drive source, allowing the second rotate member 186 to connect to the second drive source. This enables the second drive source to drive the second rotate member 186 to rotate.

The second unlock mechanism is detachably arranged on the housing 182. The second unlock mechanism is movable relative to the housing 182. In certain embodiments, the second unlock mechanism may be connected to the cartridge 180 via a shaft. The second unlock mechanism may rotate about the shaft, thereby allowing the second unlock mechanism to be rotatably connected to the cartridge 180. Alternatively, the second unlock mechanism may also be rotatably connected to the cartridge 180 via other structures, the present disclosure does not further elaborate on this.

In certain embodiments, the second unlock mechanism may be connected to the cartridge 180 via a slide rail. The second unlock mechanism may move along the slide rail, thereby enabling it to be movably connected to the cartridge 180. The second unlock mechanism may also be connected to the housing 182 via a slide rail. The second unlock mechanism may move along the slide rail, thereby enabling it to be movably connected to the housing 182. Of course, the second unlock mechanism may also be movably connected to the cartridge 180 via other structures, the present disclosure does not further elaborate on this.

In certain embodiments, the first unlock mechanism 110 is rotatably connected to the cartridge 180, and the second unlock mechanism is movably connected to the cartridge 180. Alternatively, the first unlock mechanism 110 is movably connected to the cartridge 180, and the second unlock mechanism is rotatably connected to the cartridge 180. Of course, the cartridge 180 may include a greater number of unlock mechanisms to unlock a greater number of drive sources, and the cartridge 180 may include a greater number of rotate members, with the unlocked drive sources and rotate members connected together, the present disclosure does not impose restriction on this.

To ensure the second unlock mechanism may successfully unlock the second drive source, neither the first rotate member 181 nor the second rotate member 186 will interfere with the second unlock mechanism. When the second unlock mechanism is at a state of unlocking the second drive source, at least a portion of the second unlock mechanism is located outside the area formed between the first common tangent A1 and the second common tangent A2 and the first rotate member 181 and the second rotate member 186. When the second unlock mechanism is at a state of unlocking the second drive source, a portion of the second unlock mechanism is located outside the area formed between the first common tangent A1 and the second common tangent A2 and the first rotate member 181 and the second rotate member 186. Therefore, a portion of the second unlock mechanism protrudes beyond the area, preventing the first rotate member 181 from interfering with the second unlock mechanism, preventing the second rotate member 186 from interfering with the second unlock mechanism, and also preventing the first rotate member 181 and the second rotate member 186 on the cartridge 180 from increasing design difficulty due to space constraints. At the same time, it further ensures that a portion of the second unlock mechanism may contact and unlock the second drive source, enabling the second unlock mechanism to unlock the second drive source normally, and ensuring the stable operation of the cartridge 180. This achieves the stability of maintaining image quality and the rationality of the miniaturized layout of the cartridge 180 structure.

To ensure the second unlock mechanism may successfully unlock the second drive source, neither the first rotate member 181 nor the second rotate member 186 will interfere with the second unlock mechanism. When the second unlock mechanism is at a state of unlocking the second drive source, at least a portion of the second unlock mechanism is located outside the area formed between the first common tangent A1a, the second common tangent A2a and the first rotate member 181, and outside the area formed between the first common tangent A1a, the second common tangent A2a and the second rotate member 186. When the second unlock mechanism is at a state of unlocking the second drive source, a portion of the second unlock mechanism is located outside the area formed between the first common tangent A1a, the second common tangent A2a and the first rotate member 181, and outside the area formed between the first common tangent A1a, the second common tangent A2a and the second rotate member 186. Therefore, a portion of the second unlock mechanism protrudes beyond the area, preventing the first rotate member 181 from interfering with the second unlock mechanism, preventing the second rotate member 186 from interfering with the second unlock mechanism, and also preventing the first rotate member 181 and the second rotate member 186 on the cartridge 180 from increasing design difficulty due to space constraints. At the same time, it further ensures that a portion of the second unlock mechanism may contact and unlock the second drive source, enabling the second unlock mechanism to unlock the second drive source normally, and ensuring the stable operation of the cartridge 180. This achieves the stability of maintaining image quality and the rationality of the miniaturized layout of the cartridge 180 structure.

A cartridge 180 is detachably arranged on the image forming apparatus body 162. The cartridge 180 is detachably connected to the body 162. A first rotate member 181 is detachably connected to the body 162. A second rotate member 186 is detachably connected to the body 162. In certain embodiments, as shown in FIGS. 7 and 8, the first drive source 161 includes a third rotate member 166, which is located on the image forming apparatus body 162. The third rotate member 166 includes a drive structure such as a gear or shaft, and is connected to the first rotate member 181 so that the third rotate member 166 may drive the first rotate member 181 to rotate. The first rotate member 181 is used to mesh with the third rotate member 166. The size of the protrusion of the third rotate member 166 is clearance-fitted with the first rotate member 181, and the clearance size does not exceed 1 mm.

When the first unlock mechanism 110 is at a state of unlocking the first drive source 161, the first rotate member 181 engages with the third rotate member 166. When the first rotate member 181 and the third rotate member 166 are engaged, as shown in FIG. 3, in the rotational axis direction of the first rotate member 181, at least a portion of the first unlock mechanism 110 protrudes beyond the first rotate member 181. When the first rotate member 181 and the third rotate member 166 are engaged, a portion of the first unlock mechanism 110 protrudes beyond the first rotate member 181 in the rotational axis direction. Therefore, a portion of the first unlock mechanism 110 protrudes beyond the first rotate member 181, preventing the first rotate member 181 from interfering with the first unlock mechanism 110. This also avoids increasing the design difficulty of the first rotate member 181 and the second rotate member 186 on the cartridge 180 due to space constraints. At the same time, it further ensures that the first unlock mechanism 110 may unlock the first drive source 161 normally, enabling the first rotate member 181 and the third rotate member 166 to engage without separating, and ensuring the stable operation of the cartridge 180. This achieves the stability of maintaining image quality and the rationality of the miniaturized layout of the cartridge 180 structure.

When the first rotate member 181 engages with the third rotate member 166, the entire first unlock mechanism 110 protrudes beyond the first rotate member 181 along its rotation axis. This ensures that the first unlock mechanism 110 does not interfere with the first rotate member 181, avoids increased design complexity due to space constraints between the first rotate member 181 and the second rotate member 186 on the cartridge 180, and further guarantees that the first unlock mechanism 110 may normally unlock the first drive source 161. This also ensures that the first rotate member 181 and the third rotate member 166 engage without separating, guarantees stable operation of the cartridge 180, maintains stable image quality, and achieves a reasonable miniaturized layout for the cartridge 180.

The first rotate member 181 also includes an end face facing the third rotate member 166. When the first unlock mechanism 110 is at a state of unlocking the first drive source 161, the first unlock mechanism 110 protrudes beyond the end face of the first rotate member 181. The second rotate member 186 also includes an end face facing the fourth rotate member. When the second unlock mechanism is at a state of unlocking the second drive source, the second unlock mechanism protrudes beyond the end face of the second rotate member 186.

When the second unlock mechanism is at a state of unlocking the second drive source, the entire second unlock mechanism is located outside the area formed between the first common tangent A1 and the second common tangent A2 and the first rotate member 181 and the second rotate member 186. Therefore, the entire second unlock mechanism protrudes beyond the area, preventing the first rotate member 181 from interfering with the second unlock mechanism, preventing the second rotate member 186 from interfering with the second unlock mechanism, and also avoiding increased design difficulty for the first rotate member 181 and the second rotate member 186 on the cartridge 180 due to space constraints. Simultaneously, it further ensures that the entire second unlock mechanism may contact and unlock the second drive source, enabling the second unlock mechanism to normally unlock the second drive source and ensuring the stable operation of the cartridge 180. This maintains the stability of the image quality and the rationality of the miniaturized layout of the cartridge 180 structure.

When the second unlock mechanism is at a state of unlocking the second drive source, the entire second unlock mechanism is located outside the area formed between the first common tangent A1a and the second common tangent A2a and the first rotate member 181, and outside the area formed between the first common tangent A1a and the second common tangent A2a and the second rotate member 186. Therefore, the entire second unlock mechanism protrudes beyond the designated areas, preventing the first rotate member 181 from interfering with the second unlock mechanism, preventing the second rotate member 186 from interfering with the second unlock mechanism, and also preventing the first rotate member 181 and the second rotate member 186 on the cartridge 180 from increasing design difficulty due to space constraints. Simultaneously, it further ensures that the entire second unlock mechanism may contact and unlock the second drive source, enabling the second unlock mechanism to normally unlock the second drive source and ensuring the stable operation of the cartridge 180. This achieves the stability of image quality and the rationality of the miniaturized layout of the cartridge 180 structure.

The cartridge 180 is detachably arranged on the image forming apparatus body 162. The cartridge 180 is detachably connected to the body 162. In certain embodiments, the second drive source includes a fourth rotate member located on the image forming apparatus body 162. The fourth rotate member includes a drive structure such as a gear or shaft, and is connected to the second rotate member 186 so that the fourth rotate member may drive the second rotate member 186 to rotate. The second rotate member 186 is used to engage with the fourth rotate member.

When the second unlock mechanism is at a state of unlocking the second drive source, the second rotate member 186 engages with the fourth rotate member. When the second rotate member 186 engages with the fourth rotate member, at least a portion of the second unlock mechanism protrudes beyond the second rotate member 186 in the direction of its rotation axis. Thus, the protrusion of a portion of the second unlock mechanism out of the second rotate member 186 avoids interference from the second rotate member 186 with the second unlock mechanism. It also avoids increased design difficulty for the first rotate member 181 and the second rotate member 186 on the cartridge 180 due to space constraints. Furthermore, it ensures that the second unlock mechanism may normally unlock the second drive source, achieving engagement between the second rotate member 186 and the fourth rotate member without separation, and ensuring stable operation of the cartridge 180. This achieves the stability of image quality and the rationality of the miniaturized layout of the cartridge 180 structure.

When the second rotate member 186 engages with the fourth rotate member, the entire second unlock mechanism protrudes beyond the second rotate member 186 along its rotation axis. This ensures that the second unlock mechanism does not interfere with the second rotate member 186, avoids increased design complexity due to space constraints between the first rotate member 181 and the second rotate member 186 on the cartridge 180, and further guarantees that the second unlock mechanism may normally unlock the second drive source, achieving engagement between the second rotate member 186 and the fourth rotate member without separation, and ensuring stable operation of the cartridge 180. This achieves the stability of image quality and the rationality of the miniaturized layout of the cartridge 180 structure.

The first unlock mechanism 110 is movable relative to the cartridge 180. In certain embodiments, the first unlock mechanism 110 is movable between the inside and outside of the area formed between the first common tangent A1 and the second common tangent A2 and the first rotate member 181 and the second rotate member 186.

The first unlock mechanism 110 is movable relative to the cartridge 180. In certain embodiments, the first unlock mechanism 110 is movable between the inside and outside of the area formed between the first common tangent A1a and the second common tangent A2a and the first rotate member 181, and between the inside and outside of the area formed between the first common tangent A1a and the second common tangent A2a and the second rotate member 186.

The first unlock mechanism 110, located inside the area, may rotate to the outside of the area. Alternatively, the first unlock mechanism 110, located inside the area, may move to the outside of the area. The first unlock mechanism 110, located inside the area, may be received within the area. For example, the first unlock mechanism 110, located inside the area, may be foldably received within the area. The first unlock mechanism 110, located inside the area, does not protrude beyond the first rotate member 181. The first unlock mechanism 110, located outside the area, may unlock the first drive source 161.

The first unlock mechanism 110 may also be fixed to the cartridge 180. The first unlock mechanism 110 may be integrally formed with the cartridge 180. The first unlock mechanism 110 is integrally formed with the housing 182 of the cartridge 180. The first unlock mechanism 110 may also be connected to the cartridge 180 by injection molding. The first unlock mechanism 110 is located to the side of the first rotate member 181. The first unlock mechanism 110 is integrally formed with the housing 182. The first unlock mechanism 110 is fixed relative to the housing 182. The second unlock mechanism may also be fixed to the cartridge 180. The second unlock mechanism is integrally formed with the housing 182 of the cartridge 180. The second unlock mechanism may also be connected to the cartridge 180 by injection molding. The second unlock mechanism is located to the side of the second rotate member 186. The second unlock mechanism is integrally formed with the housing 182. The second unlock mechanism is fixed relative to the housing 182. Thus, good connection strength between the adapter 100 and the cartridge 180 is ensured.

In certain embodiments, multiple cartridges 180 may be respectively arranged to the image forming apparatus body 162. Each cartridge includes at least one develop assembly, and each develop assembly is arranged to the image forming apparatus body 162 via the housing 182 of its respective cartridge 180. The developers in the multiple cartridges 180 are of different colors; the developers described herein may be toner. This allows for the generation of patterns of different colors. When multiple cartridges 180 are respectively arranged to the image forming apparatus body 162, cartridges 180 containing different colors may be arranged in the wrong position. Therefore, first unlock mechanisms of different sizes are arranged on the cartridges 180 containing different colors of developers, or first unlock mechanisms of different sizes are arranged at different positions on the cartridges 180 containing different colors of developers, to prevent users from installing cartridges 180 containing different colors of developers in the wrong position when arranging them to the image forming apparatus body 162, thus affecting print quality.

The more detailed structure of the first unlock mechanism 110 will be described below.

The first unlock mechanism 110 includes a connect portion 101 and a force-apply portion 105, which are connected together. The connect portion 101 and the force-apply portion 105 are connected along the movement direction of the first unlock mechanism 110. The connect portion 101 is closer to the housing 182 in comparison to the force-apply portion 105. The connect portion 101 includes a first connect end and a second connect end, located at opposite ends of the connect portion 101 along the movement direction of the first unlock mechanism 110. The first connect end is used to connect to the housing 182. The first connect end may be fixed to the housing 182. In certain embodiments, the first unlock mechanism 110 further includes a reinforce rib located at the connection between the first connect end and the housing 182. The reinforce rib enhances the connection strength between the first connect end and the housing 182.

The first connect end may also be detachably connected to the housing 182. The first connect end may be connected to the housing 182 by plugging it in. The connect portion 101 may be constructed as a plate-like structure. The housing 182 may be provided with a groove, and the connect portion 101 may be inserted into the groove.

The second connect end is used to connect the force-apply portion 105. The force-apply portion 105 is closer to the first drive source 161 in comparison to the connect portion 101. The force-apply portion 105 is used to unlock the first drive source 161. In order for the force-apply portion 105 to unlock the first drive source 161, the force-apply portion 105 includes an abut face 103. The force-apply portion 105 abuts against the mate structure of the first drive source 161 through the abut face 103 to unlock the first drive source 161. The abut face 103 contacts the mate structure. The force-apply portion 105 applies a force to the mate structure through the abut face 103. The force-apply portion 105 may unlock the mate structure to unlock the first drive source 161. The first drive source 161 is unlocked, thereby protruding towards the cartridge 180, thereby connecting the first drive source 161 and the first connect member.

To ensure that the force-apply portion 105 may accurately unlock the first drive source 161, the force-apply portion 105 also includes a protrude structure 102, which protrudes beyond the abut face 103. The protrude structure 102 protrudes towards the first drive source 161. The protrude structure 102 protrudes beyond the connect portion 101 towards the first drive source 161. The protrude structure 102 protrudes beyond the second connect end of the connect portion 101 towards the first drive source 161. The protrude structure 102 and the abut face 103 may be constructed as one unit. The abut face 103 of the protrude structure 102 may contact the mate structure. The protrude structure 102 applies force to the mate structure through the abut face 103 to unlock the first drive source 161.

The protrude structure 102 and the abut face 103 may also be configured as separate structures. In certain embodiments, the protrude structure 102 is located to the side of the mate structure of the first drive source 161. The abut face 103 is located at the second connect end of the connect portion 101. The abut face 103 may contact the mate structure. The connect portion 101 applies force to the mate structure through the abut face 103 to unlock the first drive source 161. The protrude structure 102 is located to the side of the abut face 103. The protrude structure 102 may be located to the side of the abut face 103 in a direction perpendicular to the movement direction of the first unlock mechanism 110. The protrude structure 102 is located to the side of the first drive source 161. Thus, the protrude structure 102 may play a position-limit role, so that the abut face 103 remains in contact with the mate structure.

To ensure smooth contact between the abut face 103 and the mate structure, the connect portion 101 further includes a slope face 104, located at the end away from the protrude structure 102. The slope face 104 is located at the second connect end of the connect portion 101. The slope face 104 is located at the end of the second connect end of the connect portion 101 away from the protrude structure 102. The slope face 104 is connected to the abut face 103. The slope face 104 is inclined outward from the abut face 103 towards the housing 182. The included angle between the slope face 104 and the abut face 103 may be greater than 180°. Therefore, the slope face 104 may guide the contact between the first unlock mechanism 110 and the first drive source 161. In particular, the slope face 104 may guide the contact between the abut face 103 and the mate structure.

In certain embodiments, the force-apply portion 105 and the connect portion 101 are integrally formed. The force-apply portion 105 and the connect portion 101 may be constructed as an integral unit. The first unlock mechanism 110 is constructed as an integral unit. Thus, it has good structural strength. In certain embodiments, the force-apply portion 105 is detachably arranged on the connect portion 101. The force-apply portion 105 may be installed on the connect portion 101 by way of bolts or other connect members. The force-apply portion 105 is configured as a force-applying member that applies force to the first drive source 161, and the force-apply portion 105 may be removed from the connect portion 101 for easy maintenance.

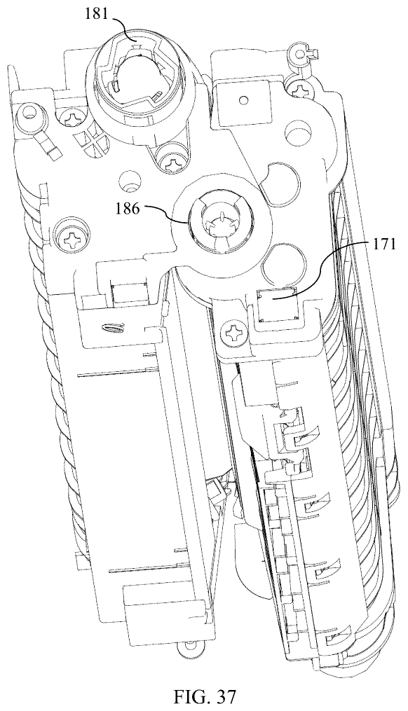

To facilitate connection between the cartridge 180 and electrical components, as shown in FIGS. 37 to 39, the cartridge 180 includes a first conductive contact 171 and a second conductive contact. The first conductive contact 171 is fixed to the housing 182. The first conductive contact 171 is connected to the housing 182 by welding. The second conductive contact is fixed to the housing 182. The second conductive contact is connected to the housing 182 by welding. A first unlock mechanism 110 is located between the first conductive contact 171 and the second conductive contact. The image forming apparatus also includes a third conductive contact and a fourth conductive contact, both of which are fixedly connected to the image forming apparatus body 162.

The first conductive contact 171 contacts the magnetic roller. In the longitudinal direction of the installation direction of the cartridge 180, after the cartridge 180 is arranged in the designed position, the first conductive contact 171 of the cartridge 180 contacts the third conductive contact of the image forming apparatus to supply power to the magnetic roller. The first unlock mechanism 110 is located above the first conductive contact 171 and the third conductive contact of the cartridge 180.

The second conductive contact contacts the magnetic roller. After the cartridge 180 is arranged in the designed position, the second conductive contact of the cartridge 180 contacts the fourth conductive contact of the image forming apparatus to supply power to the magnetic roller. The second unlock mechanism is located above the second and fourth conductive contacts.

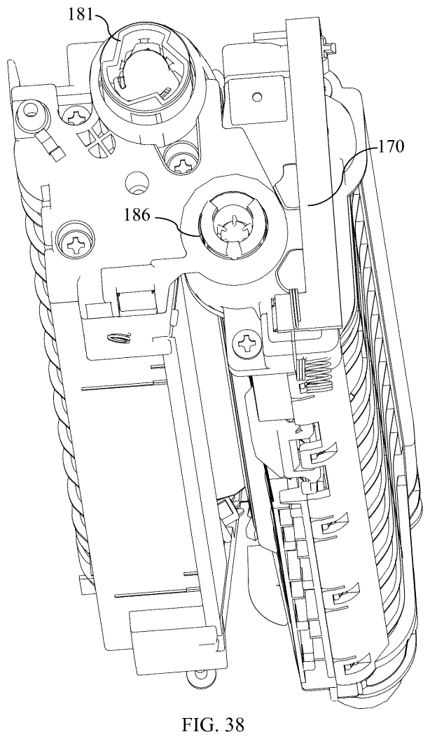

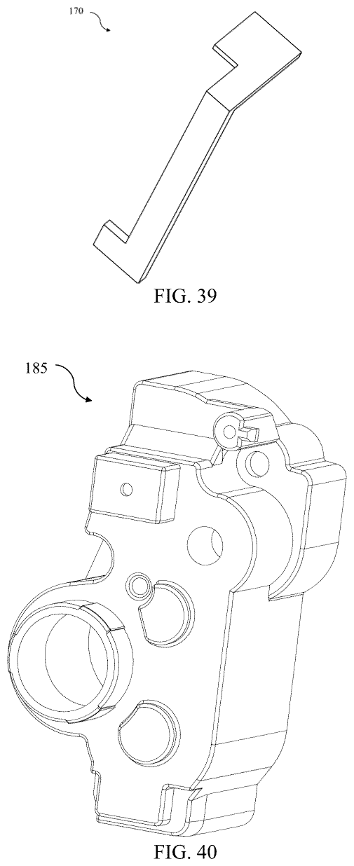

As shown in FIGS. 38 and 39, the cartridge 180 also includes a mediator 170. The mediator 170 is a metal component. The conductive contacts of the cartridge 180 are positioned above the first rotate member 181. One end of the mediator 170 is connected to the first conductive contact 171, and the other end is positioned at a contact point of the cartridge 180 that allows it to contact the third conductive contact of the image forming apparatus.

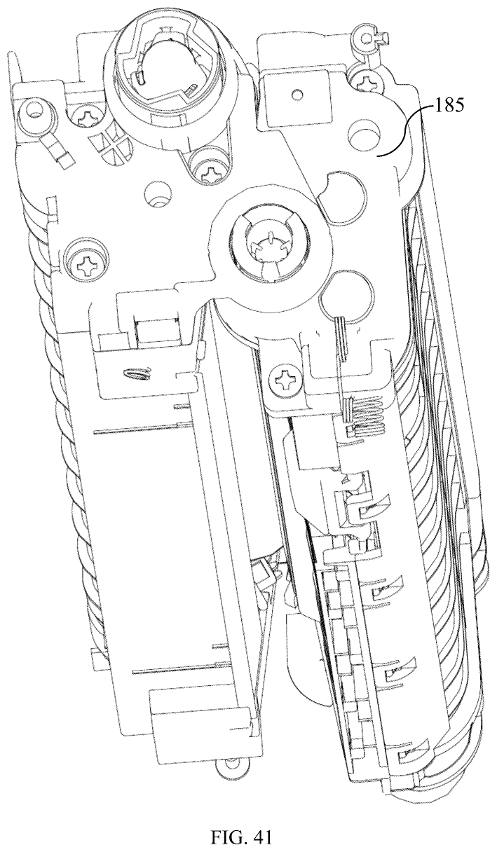

In the embodiments shown in FIG. 40, the cartridge 180 also includes an end cap 185, which may be entirely made of a conductive material. In the embodiments shown in FIG. 41, the end cap 185 may also have a large-format metal sheet, which may contact the third conductive contact of the image forming apparatus, thus enabling the cartridge 180 to conduct electricity.

The present disclosure in certain embodiments also provides a cartridge set detachably arranged on the body 162 of the image forming apparatus. The cartridge set includes the aforementioned cartridge 180.

According to the cartridge set of the present disclosure, detachably arranged on the body 162 of the image forming apparatus, the cartridge set includes the aforementioned cartridge 180. The cartridge 180 includes a housing 182, a first rotate member 181, and a first unlock mechanism 110. The first rotate member 181 is arranged on the housing 182, and the first unlock mechanism 110 is used to unlock the first drive source 161, allowing the first rotate member 181 to connect to the first drive source 161. This reduces the operation force required to install the cartridge 180, solving the problem of excessive operation force when installing the cartridge 180 into the image forming apparatus, or preventing direct hard impact between the first rotate member 181 and the first drive source 161 due to excessive operation force. This avoids damage to the first rotate member 181 and the first drive source 161 caused by impact, ensuring normal connection between the first rotate member 181 and the first drive source 161, and improving the reliability of the image forming apparatus.

The cartridge set may be arranged onto the body 162 of the image forming apparatus. The cartridge set includes at least one cartridge 180, each of which is arranged onto the image forming apparatus body 162. The at least one cartridge 180 is detachably arranged onto the image forming apparatus body 162. The cartridge set includes at least one develop assembly, each of which is arranged onto the image forming apparatus body 162 via the housing 182 of its respective cartridge 180. The developers in the multiple cartridges are of different colors; the developers described herein may be toner. Thus, patterns of different colors may be generated.

Multiple cartridges 180 are arranged in a row. This facilitates installation onto the image forming apparatus body 162. The first unlock mechanisms 110 of the multiple cartridges 180 are all of different sizes. The first unlock mechanisms 110 of different cartridges 180 are all of different sizes. Therefore, it is possible to accommodate different installation configurations of the cartridges 180, ensuring that the rotate members of each cartridge 180 are connected to their respective drive sources.

The present disclosure in certain embodiments also provides an image forming apparatus, which includes a body 162 and the aforementioned cartridges 180. The cartridges 180 are detachably arranged on the body 162.

The image forming apparatus according to the present disclosure includes a body 162 and the aforementioned cartridge 180, where the cartridge 180 is detachably arranged to the body 162. The cartridge 180 includes a housing 182, a first rotate member 181, and a first unlock mechanism 110. The first rotate member 181 is arranged on the housing 182, and the first unlock mechanism 110 is used to unlock the first drive source 161, allowing the first rotate member 181 to connect to the first drive source 161. This reduces the operation force required to install the cartridge 180, solving the problem of excessive operation force when installing the cartridge 180 into the image forming apparatus, or preventing direct hard impact between the first rotate member 181 and the first drive source 161 due to excessive operation force, thus avoiding damage to the first rotate member 181 and the first drive source 161 caused by impact, ensuring normal connection between the first rotate member 181 and the first drive source 161, and improving the reliability of the image forming apparatus.

The present disclosure also provides an image forming apparatus, including a body 162 and the aforementioned cartridge set. The cartridge set is detachably arranged to the body 162.

The image forming apparatus according to certain embodiments of the present disclosure includes a body 162 and the cartridge set described herein. The cartridge set is detachably arranged on the body 162. The cartridge set includes the cartridge 180. The cartridge 180 includes a housing 182, a first rotate member 181, and a first unlock mechanism 110. The first rotate member 181 is arranged on the housing 182, and the first unlock mechanism 110 is used to unlock the first drive source 161, so that the first rotate member 181 may be connected to the first drive source 161. In this way, the operation force for installing the cartridge 180 is reduced, which may solve the problem of excessive operation force when installing the cartridge 180 into the image forming apparatus, or may solve the problem of direct hard impact between the first rotate member 181 and the first drive source 161 due to excessive operation force, avoid the problem of damage to the first rotate member 181 and the first drive source 161 due to impact, ensure that the first rotate member 181 and the first drive source 161 may be properly connected, and improve the reliability of the image forming apparatus.

The present disclosure in certain embodiments also provides an image forming apparatus, which includes a body 162 for connection to a cartridge 180. To facilitate connection between the body 162 and the cartridge 180, the body 162 is also provided with a socket for installation of the cartridge 180.

The image forming apparatus includes a third rotate member 166, which is arranged on the body 162. The third rotate member 166 engages with a first rotate member 181 of the cartridge 180. The third rotate member 166 is located on the body 162 of the image forming apparatus. The third rotate member 166 includes a drive structure such as a gear or shaft, and is connected to the first rotate member 181 so that the third rotate member 166 may drive the first rotate member 181 to rotate. The first rotate member 181 engages with the third rotate member 166.

As shown in FIG. 1, the image forming apparatus further includes a first restrain mechanism 121, which is arranged on the body 162. The first restrain mechanism 121 may limit the third rotate member 166. In certain embodiments, when the cartridge 180 is not inserted into the image forming apparatus body 162, as shown in FIG. 15, the first restrain mechanism 121 is used to limit the third rotate member 166 to a first position. The first restrain mechanism 121 abuts against the third rotate member 166. The first restrain mechanism 121 limits the third rotate member 166 from protruding towards the cartridge 180. The third rotate member 166 in the first position is not in contact with the first rotate member 181 of the cartridge 180. The third rotate member 166 in the first position is not connected to the first rotate member 181 of the cartridge 180.

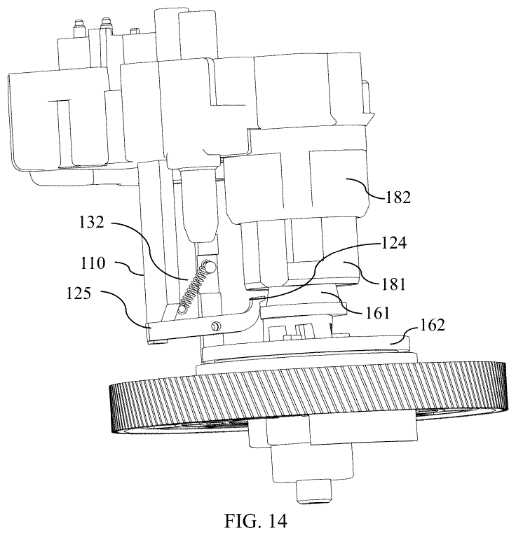

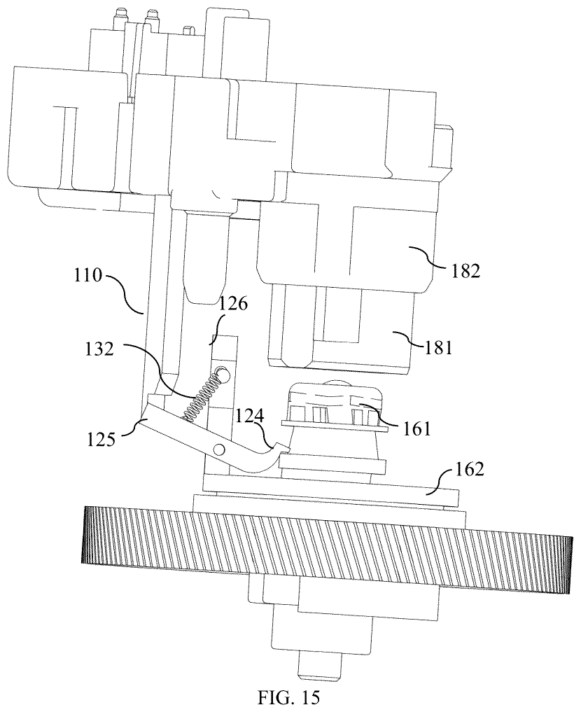

When the cartridge 180 is inserted into the image forming apparatus body 162 and installed in place, as shown in FIG. 14, the first unlock mechanism 110 of the cartridge 180 cooperates with the first restrain mechanism 121 to position the third rotate member 166 in the second position, releasing the restriction of the first restrain mechanism 121 on the third rotate member 166, and realizing the engagement of the first rotate member 181 and the third rotate member 166. The first unlock mechanism 110 cooperates with the first restrain mechanism 121. The first unlock mechanism 110 unlocks the first restrain mechanism 121. In this way, the third rotate member 166 in the first position may move to the second position. The third rotate member 166 in the first position may move toward the cartridge 180. The third rotate member 166 in the second position protrudes toward the cartridge 180. The third rotate member 166 in the second position may extend out of the image forming apparatus body 162. The third rotate member 166 in the second position may be locked in the axial direction of the third rotate member 166 to prevent axial movement and affect the transmission of drive force. The third rotate member 166, located in the second position, is in contact with the first rotate member 181. The third rotate member 166, located in the second position, is connected to the first rotate member 181. The third rotate member 166, located in the second position, is capable of engaging with the first rotate member 181.

According to the image forming apparatus of the present disclosure, the image forming apparatus body 162 is provided with an insertion port for receiving a cartridge 180. The image forming apparatus includes the body 162, a third rotate member 166, and a first restrain mechanism 121. The third rotate member 166 is arranged on the body 162 and is used to engage with the first rotate member 181 of the cartridge 180. The first restrain mechanism 121 is arranged on the body 162. When the cartridge 180 is not inserted into the image forming apparatus body 162, the first restrain mechanism 121 is used to limit the third rotate member 166 to a first position. When the cartridge 180 is inserted into the image forming apparatus body 162 and arranged in place, the first unlock mechanism 110 of the cartridge 180 cooperates with the first restrain mechanism 121 to make the third rotate member 166 a second position, thereby releasing the restriction of the first restrain mechanism 121 on the third rotate member 166 and realizing the engagement of the first rotate member 181 and the third rotate member 166. In this way, reducing the operation force required to install the cartridge 180 may solve the problem of excessive operation force when installing the cartridge 180 into the image forming apparatus, or may solve the problem of direct hard impact between the first rotate member 181 and the third rotate member 166 due to excessive operation force, thus avoiding damage to the first rotate member 181 and the third rotate member 166 caused by impact, ensuring that the first rotate member 181 and the third rotate member 166 may be properly connected, and improving the reliability of the image forming apparatus.

In certain embodiments, as shown in FIG. 6, the first restrain mechanism 121 includes a lock member 122, which is movable between a restricted position and a released position. The lock member 122 is connected to the image forming apparatus body 162. The lock member 122 is movably connected to the image forming apparatus body 162. The lock member 122 is capable of locking the third rotate member 166. The lock member 122 in the restricted position is capable of preventing the third rotate member 166 from moving outward. The first unlock mechanism 110 is capable of unlocking the lock member 122, allowing the lock member 122 in the restricted position to move to the released position.

When the lock member 122 is in the restricted position, it restricts the third rotate member 166. The lock member 122 in the restricted position constrains the third rotate member 166. The lock member 122 in the restricted position may space the third rotate member 166 from the first rotate member 181. When the cartridge 180 is inserted into the image forming apparatus body 162 and arranged in place, the lock member 122 may move to the released position under the action of the first unlock mechanism 110, and the lock member 122 in the released position may release the third rotate member 166. As shown in FIGS. 10 and 11, the third rotate member 166 in the second position may extend out of the image forming apparatus body 162. The third rotate member 166 in the second position may be locked in the axial direction to prevent axial movement and thus avoid affecting the transmission of drive force. In this way, the lock member 122 in the restricted position allows the third rotate member 166 to remain in the first position, preventing the third rotate member 166 from applying a rigid connection force to the first rotate member 181 and reducing damage to the first rotate member 181. The lock member 122 in the released position may release the third rotate member 166, allowing it to move to the second position, thereby enabling the third rotate member 166 in the second position to connect with the first rotate member 181.

The lock member 122 includes a receive portion and a pressure-apply portion, which are connected together. The receive portion is used to contact the first unlock mechanism 110. The pressure-apply portion is used to contact the third rotate member 166. The pressure-apply portion is movable between a restricted position and a released position. In the restricted position, the pressure-apply portion abuts against the third rotate member 166. In the restricted position, the pressure-apply portion may apply force to the third rotate member 166. In the released position, the pressure-apply portion is spaced apart from the third rotate member 166. In the released position, the pressure-apply portion may release the third rotate member 166.

When the cartridge 180 is not inserted into the image forming apparatus body 162, the lock member 122 is in the restricted position, and the pressure-apply portion abuts against the third rotate member 166. The first unlock mechanism 110 does not unlock the lock member 122. The cartridge 180 is spaced apart from the image forming apparatus body 162. The first unlock mechanism 110 is not in contact with the lock member 122. The lock member 122 in the restricted position is spaced apart from the first unlock mechanism 110. The lock member 122 in the restricted position applies a force to the third rotate member 166. The pressure-apply portion of the lock member 122 in the restricted position abuts against the third rotate member 166. The pressure-apply portion of the lock member 122 in the restricted position applies a force to the third rotate member 166.

During the insertion and installation of the cartridge 180 into the image forming apparatus body 162, the receive portion abuts against the first unlock mechanism 110, causing the lock member 122 to move from the restricted position to the released position. Then, the pressure-apply portion releases the third rotate member 166. The cartridge 180 moves toward the image forming apparatus body 162. The first unlock mechanism 110 unlocks the lock member 122. The lock member 122 contacts the first unlock mechanism 110. The receive portion of the lock member 122 abuts against the first unlock mechanism 110. The first unlock mechanism 110 applies force to the receive portion of the lock member 122, causing the lock member 122 to move from the restricted position to the released position. The lock member 122 in the released position unlocks the third rotate member 166. The pressure-apply portion of the lock member 122 in the released position is spaced apart from the third rotate member 166. The pressure-apply portion of the lock member 122 in the released position releases the lock member 122.

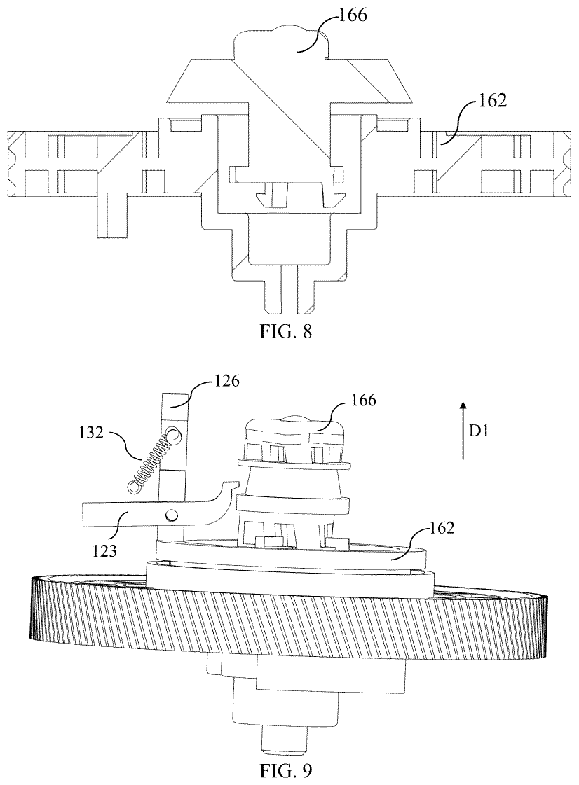

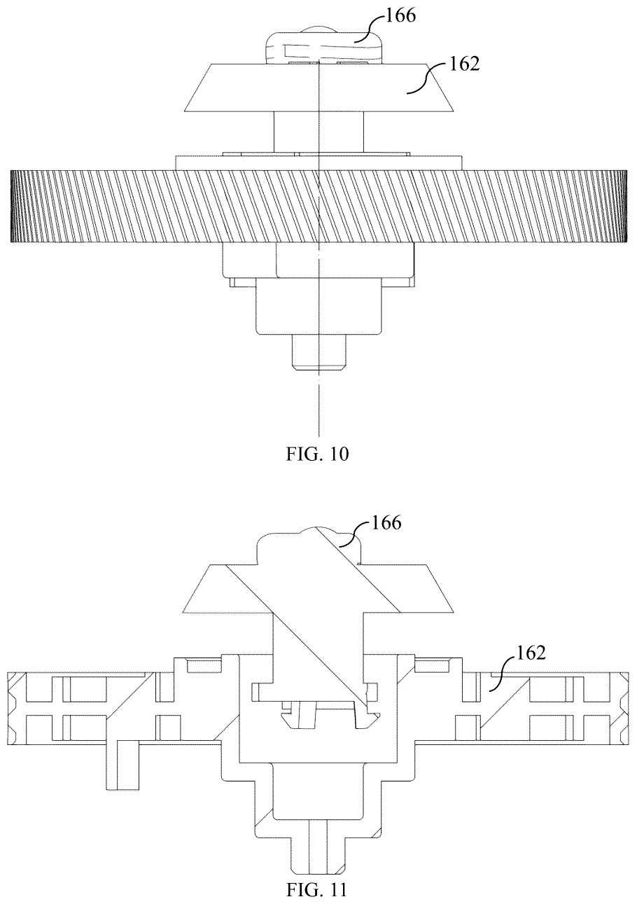

Further, as shown in FIGS. 9, 14, and 15, the lock member 122 includes a rod portion 123, which includes a first pressure-apply portion 124 and a first receive portion 125, located at opposite ends of the rod portion 123. The length direction of the rod portion 123 intersects the movement direction of the lock member 122. The first receive portion 125 is used to contact the first unlock mechanism 110. The first receive portion 125 is capable of absorbing the force applied by the first unlock mechanism 110.

As shown in FIG. 15, the first pressure-apply portion 124 is used to apply compressive force to the third rotate member 166. The first pressure-apply portion 124 is in contact with the third rotate member 166. The first pressure-apply portion 124 is movable between a restricted position and a released position. In the restricted position, the first pressure-apply portion 124 abuts against the third rotate member 166. In the restricted position, the first pressure-apply portion 124 is able to apply compressive force to the third rotate member 166. In the released position, the first pressure-apply portion 124 is spaced apart from the third rotate member 166. In the released position, the first pressure-apply portion 124 is able to release the third rotate member 166.

When the cartridge 180 is not inserted into the image forming apparatus body 162, the lock member 122 is in the restricted position, and the first pressure-apply portion 124 abuts against the third rotate member 166. The first pressure-apply portion 124 of the lock member 122 in the restricted position abuts against the third rotate member 166. The first pressure-apply portion 124 of the lock member 122 in the restricted position applies force to the third rotate member 166.

As shown in FIG. 14, during the process of inserting the cartridge 180 into the image forming apparatus body 162 and arranging it in place, the first receive portion 125 abuts against the first unlock mechanism 110, causing the lock member 122 to move from the restricted position to the released position. Then, the first pressure-apply portion 124 releases the third rotate member 166. The first receive portion 125 of the lock member 122 abuts against the first unlock mechanism 110. The first unlock mechanism 110 applies force to the first receive portion 125 of the lock member 122, causing the lock member 122 to move from the restricted position to the released position. The first pressure-apply portion 124 of the lock member 122 in the released position is spaced apart from the third rotate member 166. The first pressure-apply portion 124 of the lock member 122 in the released position releases the lock member 122.

In certain embodiments, the lock member 122 is rotatably connected to the image forming apparatus body 162. The rod portion 123 of the lock member 122 is hinged to the image forming apparatus body 162. The rod portion 123 of the lock member 122 is movable along a first direction D1. The rod portion 123 of the lock member 122 is movable along the direction in which the cartridge 180 is inserted into the image forming apparatus body 162. The rod portion 123 of the lock member 122 is movable along the first direction D1 between a restricted position and a released position. The first direction D1 is parallel to the direction in which the cartridge is inserted into the image forming apparatus body. Thus, the movement direction of the first unlock mechanism 110 is parallel to the movement direction of the rod portion 123 of the lock member 122, and the first unlock mechanism 110 and the rod portion 123 of the lock member 122 have the same movement direction, resulting in a simple structure and easy unlocking.

The first restrain mechanism 121 further includes a connect member 126, which is arranged on the body 162. The connect member 126 connects the lock member 122 and the body 162. The connect member 126 may be fixedly connected to the body 162. The connect member 126 is connected to the body 162 by injection molding. The connect member 126 may be constructed as a rod-shaped structure. The length direction of the connect member 126 is parallel to the movement direction of the first unlock mechanism 110. The end of the connect member 126 is connected to the body 162.

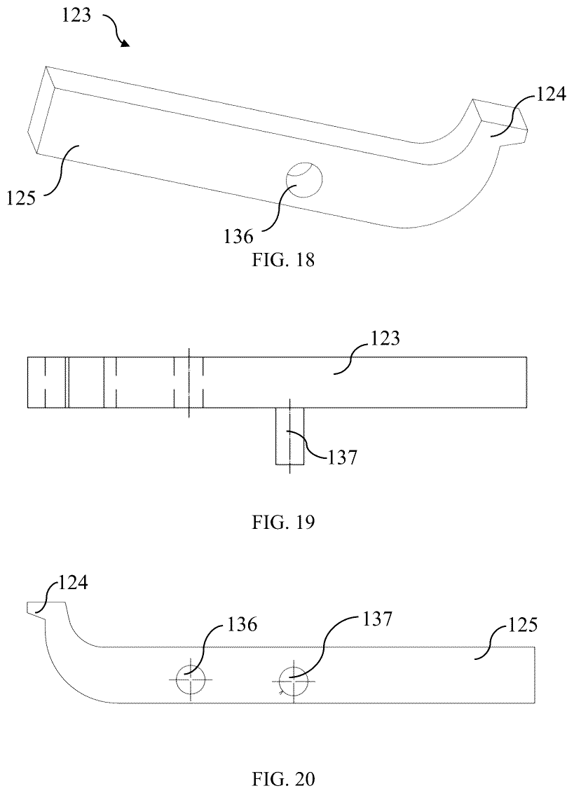

Lock member 122 is rotatably connected to connect member 126. Connect member 126 is used to hinge rod portion 123. In certain embodiments, as shown in FIGS. 18, 19, and 20, connect member 126 is provided with a pivot. The pivot protrudes beyond connect member 126. The pivot is located between the connect end and the free end of connect member 126. The axial direction of the pivot is perpendicular to the length direction of connect member 126. Rod portion 123 is provided with a groove 136 that mates with the pivot. Groove 136 is located between first pressure-apply portion 124 and first receive portion 125. In certain embodiments, groove 136 is hinged to the pivot. Thus, lock member 122 is hinged to connect member 126. Thus, lock member 122 is able to rotate about the axial direction of the pivot. Lock member 122 is able to rotate between a restricted position and a released position about the axial direction of the pivot.

In certain embodiments, the connect member 126 is provided with a groove. The rod portion 123 is provided with a pivot that engages with the groove. The pivot protrudes beyond the rod portion 123. The pivot is located between the first pressure-apply portion 124 and the first receive portion 125 of the lock member 122. The axial direction of the pivot is perpendicular to the length direction of the connect member 126. Specifically, the groove is hinged to the pivot. This allows the lock member 122 to be hinged to the connect member 126. This allows the lock member 122 to rotate about the axial direction of the pivot. The lock member 122 may rotate between a restricted position and a released position about the axial direction of the pivot.

The first unlock mechanism 110 applies a force to the first receive portion 125 in the direction toward the housing 182. The first receive portion 125 moves toward the housing 182. The first pressure-apply portion 124 moves away from the housing 182. The first pressure-apply portion 124 no longer applies compressive force to the third rotate member 166. The third rotate member 166 may then move away from the housing 182. This releases the third rotate member 166, allowing it to connect with the first rotate member 181. The first unlock mechanism 110 applies a force to the first receive portion 125 in the restricted position in the direction toward the housing 182. The first receive portion 125 in the restricted position moves toward the housing 182. The first pressure-apply portion 124 in the restricted position moves away from the housing 182 to a released position. The first pressure-apply portion 124 in the released position no longer applies compressive force to the third rotate member 166. The third rotate member 166 may move away from the housing 182.

To facilitate the return of the lock member 122 to its original position, referring back to FIGS. 9, 14, and 15, the first restrain mechanism 121 further includes a first elastic member 132, which enables the lock member 122, located in the released position, to move to the restricted position. The first elastic member 132 includes a first end and a second end, which are located at opposite ends of the elastic deformation direction of the first elastic member 132. The first end of the first elastic member 132 is connected to the connect member 126. The first end of the first elastic member 132 is fixedly or detachably connected to the connect member 126. The second end of the first elastic member 132 is connected to the rod portion 123. In certain embodiments, the rod portion 123 is further provided with a connect post 137, which is connected to the second end of the first elastic member 132. The connect post 137 is located between the first receive portion 125 and the groove 136. The second end of the first elastic member 132 is located between the first receive portion 125 and the hinge position.

When the lock member 122 is in the released position and is no longer subject to the force of the first unlock mechanism 110, the elastic force generated by the first elastic member 132 is used to reset the lock member 122 to the restricted position. When the first unlock mechanism 110 moves away from the housing 182, the lock member 122 in the released position is no longer subject to the force of the first unlock mechanism 110. The first elastic member 132 generates an elastic force and applies a force to the first receive portion 125, causing the lock member 122 to reset to the restricted position.

The first unlock mechanism 110 no longer applies a force to the first receive portion 125 in the direction toward the housing 182. The first unlock mechanism 110 moves away from the housing 182. The first receive portion 125 moves away from the housing 182. The first pressure-apply portion 124 moves toward the housing 182. The first pressure-apply portion 124 applies a compressive force to the third rotate member 166. The third rotate member 166 may move toward the housing 182. Thus, the third rotate member 166 is locked. The first unlock mechanism 110 no longer applies a force toward the housing 182 to the first receive portion 125 located in the released position. The first unlock mechanism 110 moves away from the housing 182. The first receive portion 125 located in the released position moves away from the housing 182. The first pressure-apply portion 124 located in the released position moves toward the housing 182 to the restricted position. The first pressure-apply portion 124 located in the restricted position applies a compressive force to the third rotate member 166. The third rotate member 166 may move toward the housing 182. Thus, the third rotate member 166 is locked.

In certain embodiments, the lock member 122 is movably connected to the image forming apparatus body 162. The lock member 122 includes a second pressure-apply portion 127, which is capable of applying a compressive force to the third rotate member 166. The second pressure-apply portion 127 is in contact with the third rotate member 166. The second pressure-apply portion 127 is movable between a restricted position and a released position. In the restricted position, the first pressure-apply portion 124 abuts against the third rotate member 166. In the restricted position, the second pressure-apply portion 127 applies a force to the third rotate member 166. In the released position, the second pressure-apply portion 127 is spaced apart from the third rotate member 166. In the released position, the second pressure-apply portion 127 releases the third rotate member 166.

When the cartridge 180 is not inserted into the image forming apparatus body 162, the lock member 122 is in the restricted position, and the second pressure-apply portion 127 abuts against the third rotate member 166. The second pressure-apply portion 127 of the lock member 122 in the restricted position abuts against the third rotate member 166. The second pressure-apply portion 127 of the lock member 122 in the restricted position applies force to the third rotate member 166.

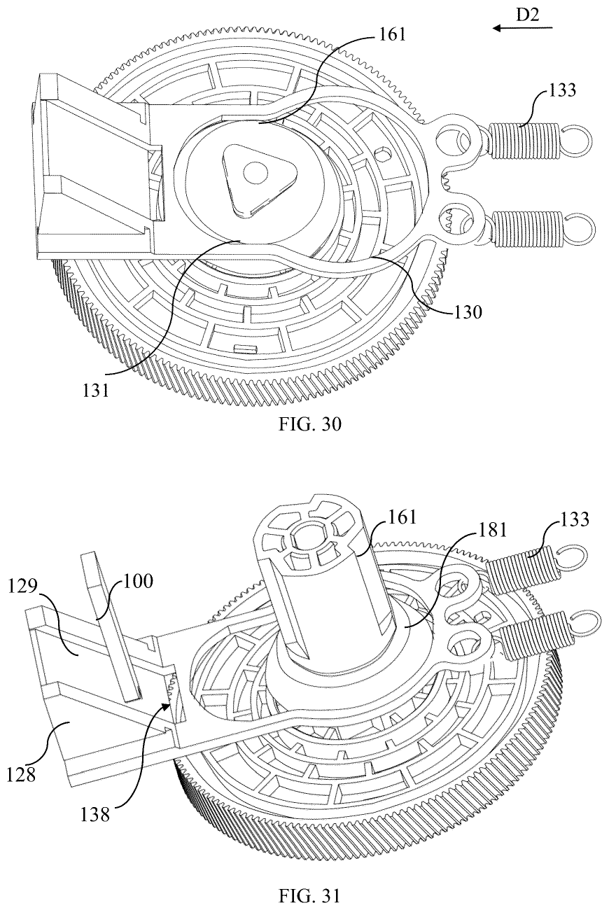

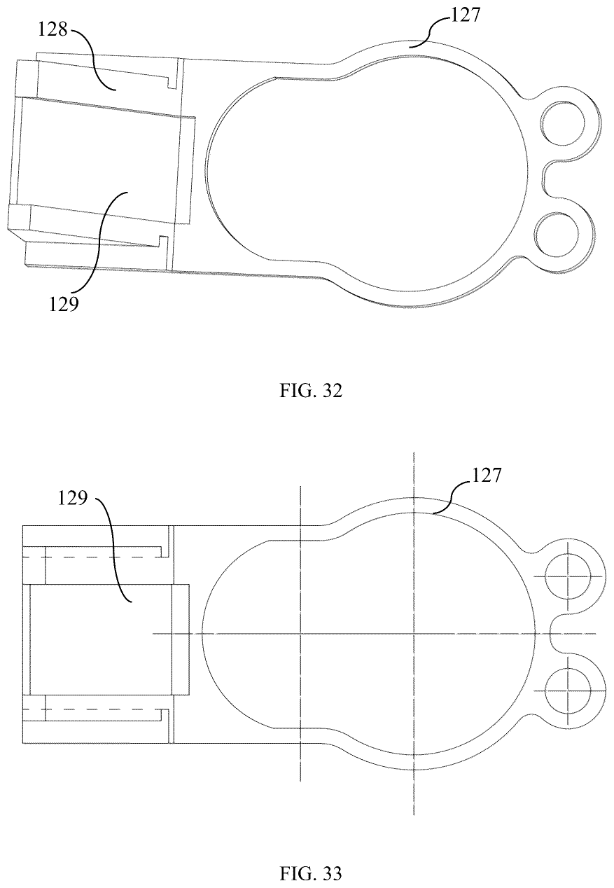

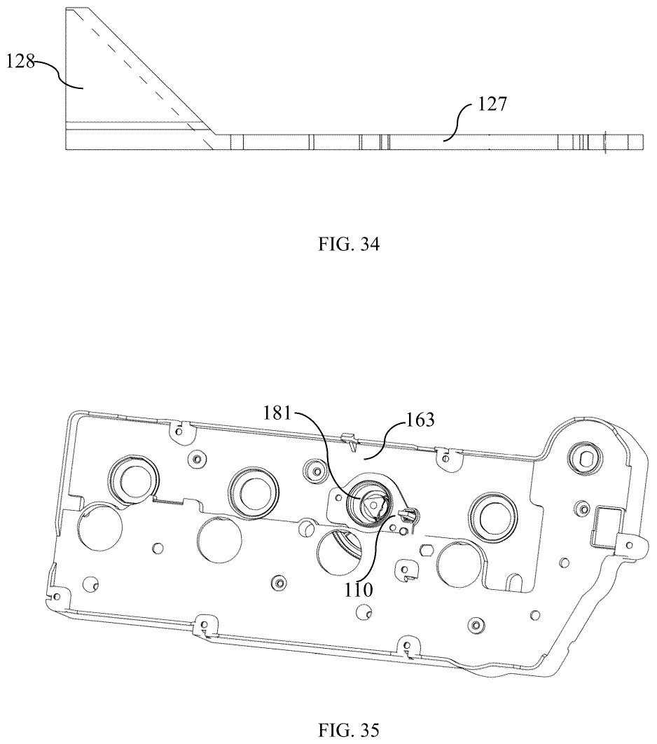

As shown in FIGS. 30 to 34, the lock member 122 further includes a second receive portion 128, which is connected to the second pressure-apply portion 127. During the process of inserting the cartridge 180 into the image forming apparatus body 162 and installing it in place, the second receive portion 128 abuts against the first unlock mechanism 110, causing the lock member 122 to move from the restricted position to the released position, after which the second pressure-apply portion 127 releases the third rotate member 166. The second receive portion 128 of the lock member 122 abuts against the first unlock mechanism 110. The first unlock mechanism 110 applies a force to the second receive portion 128 of the lock member 122, causing the lock member 122 to move from the restricted position to the released position. The second pressure-apply portion 127 of the lock member 122 in the released position is spaced apart from the third rotate member 166. The second pressure-apply portion 127 of the lock member 122 in the released position releases the lock member 122.

As shown in FIG. 32, the lock member 122 includes a second pressure-apply portion 127, which includes a first part 131 and a second part 130, with the first part 131 and the second part 130 communicating with each other. The second pressure-apply portion 127 may be configured as a ring structure. The first part 131 is configured as a ring. The second part 130 is configured as a ring. The first part 131 includes a first hole, and the second part 130 includes a second hole, with the first hole and the second hole communicating with each other. The size of the second part 130 is larger than the size of the first part 131. The diameters of the first hole and the second hole are different. The size of the second hole is larger than the size of the first hole. The size of the second part 130 in the direction perpendicular to the movement direction of the first unlock mechanism 110 is larger than the size of the first part 131. The radial dimension of the second hole is larger than the radial dimension of the first hole.

As shown in FIG. 30, when the third rotate member 166 is in the first position, the first part 131 is used to apply a compressive force to the third rotate member 166. As shown in FIG. 31, when the third rotate member 166 is in the second position, the second part 130 is used to release the third rotate member 166. In order to facilitate the connection between the third rotate member 166 and the first rotate member 181, the third rotate member 166 may protrude beyond the second part 130, or the third rotate member 166 may be flush with the second part 130.

The second pressure-apply portion 127 is movable along a second direction D2, which is perpendicular to the direction in which the cartridge 180 is inserted into the image forming apparatus body 162. The second pressure-apply portion 127 is movable in a direction perpendicular to the direction in which the cartridge 180 is inserted into the image forming apparatus body 162. The lock member 122 is movable along the second direction D2 between a restricted position and a released position. Therefore, the movement direction of the second pressure-apply portion 127 of the lock member 122 is perpendicular to the movement direction of the first unlocking structure. When the second pressure-apply portion 127 in the restricted position moves along the second direction D2 to the released position, the second pressure-apply portion 127 in the released position does not apply compressive force to the third rotate member 166, which may pass through the second hole. The first part 131 of the second pressure-apply portion 127 in the released position does not apply compressive force to the third rotate member 166.

To allow the second pressure-apply portion 127, located in the restricted position, to move to the released position, the second receive portion 128 includes a slope receive face 129 for abutting against the first unlock mechanism 110. The second receive portion 128 is constructed as a raised slope face structure. The slope receive face 129 includes a first end and a second end, with the first end being further away from the housing 182 than the second end. The first end is further away from the housing 182 than the second end in the direction along which the cartridge 180 is inserted into the image forming apparatus body 162. The first end is further away from the housing 182 than the second end along a first direction D1. The second end is closer to the second pressure-apply portion 127 in comparison to the first end along a second direction D2.

During the insertion and installation of the cartridge 180 into the image forming apparatus body 162, the slope receive face 129 is pushed by the first unlock member to move the lock member 122, thereby releasing the lock member 122 from restricting the third rotate member 166. The first unlock mechanism 110 applies a force to the second receive portion 128 in the direction toward the housing 182. Under the influence of the slope receive face 129, the second receive portion 128 moves away from the third rotate member 166 along the second direction D2. The second pressure-apply portion 127 no longer applies compressive force to the third rotate member 166. The third rotate member 166 may then move away from the housing 182. Thus, the third rotate member 166 is released, allowing it to connect with the first rotate member 181. The first unlock mechanism 110 applies a force to the second receive portion 128 in the restricted position in the direction toward the housing 182. Under the influence of the slope receive face 129, the second receive portion 128 in the restricted position moves away from the third rotate member 166 along the second direction D2. The second pressure-apply portion 127, located in the restricted position, moves to the released position along the second direction D2 in a direction away from the third rotate member 166. The second pressure-apply portion 127, located in the released position, no longer applies compressive force to the third rotate member 166. The third rotate member 166 may then move in a direction away from the housing 182.

To prevent excessive movement of the second pressure-apply portion 127, the lock member 122 further includes a notch 138, which is arranged adjacent to the slope receive face 129. After the cartridge 180 is inserted into the image forming apparatus body 162 and installed in place, the notch 138 accommodates the first unlock member. Consequently, the first unlock member stops moving towards the housing 182, does not apply force to the second receiving portion 128, the second receiving portion 128 stops moving, and the second pressure-apply portion 127 stops moving. The lock member 122 is positioned in the released position, the second receiving portion 128 of the lock member 122 is positioned in the released position, and the second pressure-apply portion 127 of the lock member 122 is positioned in the released position.

The first restrain mechanism 121 further includes a second elastic member 133, which enables the lock member 122, located in the released position, to move to the restricted position. The second elastic member 133 includes a first end and a second end, located at opposite ends of the second elastic member 133. The first end of the second elastic member 133 is connected to the lock member 122. The first end of the second elastic member 133 is fixedly or detachably connected to the second pressure-apply portion 127. The second end of the second elastic member 133 is connected to the body 162. The second end of the second elastic member 133 is fixedly or detachably connected to the body 162.

When the lock member 122 is in the released position and is no longer subject to the force of the first unlock mechanism 110, the elastic force generated by the second elastic member 133 is used to reset the lock member 122 to the restricted position. When the first unlock mechanism 110 moves away from the housing 182, the lock member 122 in the released position is no longer subject to the force of the adapter 100. The second elastic member 133 generates an elastic force, which applies a force to the second pressure-apply portion 127, causing the lock member 122 to reset to the restricted position. The elastic force of the second elastic member 133 may be tensile, compressive, or magnetic; the present disclosure is not limited to any of these, as long as the second elastic member 133 may reset the second pressure-apply portion 127.

The first unlock mechanism 110 no longer applies a force to the second receiving portion 128 in the direction toward the housing 182. The first unlock mechanism 110 moves away from the housing 182. The second receiving portion 128 moves along the second direction D2 toward the third rotate member 166. The second pressure-apply portion 127 moves toward the second elastic member 133. The second pressure-apply portion 127 applies a compressive force to the third rotate member 166. The elastic force of the second elastic member 133 is greater than the elastic force of the return member inside the third rotate member 166. The third rotate member 166 may move toward the housing 182. Thus, the third rotate member 166 is locked. The first unlock mechanism 110 no longer applies a force toward the housing 182 to the second receiving portion 128 located in the released position. The first unlock mechanism 110 moves away from the housing 182. The second receive portion 128, located in the released position, moves towards the third rotate member 166 along the second direction D2. The second pressure-apply portion 127, located in the released position, moves to the restricted position towards the second elastic member 133. The second pressure-apply portion 127, located in the restricted position, applies a compressive force to the third rotate member 166. The third rotate member 166 may then move towards the housing 182. Thus, the third rotate member 166 is locked.

The image forming apparatus also includes a return member that enables the third rotate member 166, located in the second position, to move to the first position. The return member may be configured as a tension spring. The return member includes a first end and a second end, located at opposite ends of the elastic deformation direction of the return member. The first end of the return member is connected to the body 162. The first end of the return member is fixedly or detachably connected to the body 162. The second end of the return member is connected to the third rotate member 166. The second end of the return member is fixedly or detachably connected to the third rotate member 166. When the first unlock mechanism 110 releases the first restrain mechanism 121 from restricting the third rotate member 166, the elastic force generated by the return member is used to move the third rotate member 166 to the second position.

The first unlock mechanism 110 no longer applies a force toward the housing 182 to the receive portion. The first unlock mechanism 110 moves away from the housing 182. The pressure-apply portion applies a compressive force to the third rotate member 166. The third rotate member 166 may move toward the housing 182. Thus, the third rotate member 166 is locked. The first unlock mechanism 110 moves away from the housing 182. The pressure-apply portion located in the released position moves toward the return member to the restricted position. The pressure-apply portion located in the restricted position applies a compressive force to the third rotate member 166. The third rotate member 166 may move toward the housing 182. Thus, the third rotate member 166 is locked.

The first end of the return member is connected to the body 162, and the second end of the return member is connected to the third rotate member 166. When the first unlock mechanism 110 releases the restriction mechanism on the third rotate member 166, the third rotate member 166 may move to the second position under the elastic force of the return member. During the insertion and installation of the cartridge 180 into the image forming apparatus body 162, the first unlock mechanism 110 unlocks the lock member 122, releasing the third rotate member 166. Under the elastic force of the return member, the third rotate member 166 may move to the second position. The third rotate member 166 may connect to the first rotate member 181.

When not inserted into the cartridge 180, the first restrain mechanism 121 acts on the third rotate member 166, causing the third rotate member 166 to be in a retracted state. When the third rotate member 166 is in the retracted state, it disengages from one gear of the gear train on the image forming apparatus side. Therefore, in the retracted state of the third rotate member 166, even when the gear train is activated by the drive source, the third rotate member 166, which is in a retracted state on the body 162 side, will not rotate with the external gear.

When the first unlock mechanism 110 unlocks the first restrain mechanism 121, the first restrain mechanism 121 releases the force exerted on the third rotate member 166. The third rotate member 166 extends outward from the outside of the image forming apparatus body 162, presenting an extended state. After the third rotate member 166 extends outward, it meshes with a gear in the gear train. When the gear train is turned on by the drive source, as one gear in the gear train rotates, the third rotate member 166 rotates synchronously. In this way, the cartridge 180 may operate normally.

When the cartridge 180 is removed, the first unlock mechanism 110 separates from the first restrain mechanism 121, releasing the pushing force on the first restrain mechanism 121. The elastic force of the first elastic member 132 is greater than the elastic force of the return member. Under the action of the pressure-apply portion, the drive linkage inside the third rotate member 166 overcomes the elastic force of the return member, compressing the third rotate member 166 and retracting it into the image forming apparatus body 162, thus resetting the third rotate member 166. The above actions are repeated when the cartridge 180 is reinstalled next time.

The image forming apparatus further includes a fourth rotate member arranged on the body 162. The fourth rotate member is for engaging with a second rotate member 186 of the cartridge 180. The fourth rotate member is located on the image forming apparatus body 162. The fourth rotate member includes a drive structure such as a gear or shaft, and is connected to the second rotate member 186 so that the fourth rotate member may drive the second rotate member 186 to rotate. The second rotate member 186 is for engaging with the fourth rotate member.

The image forming apparatus also includes a second restrain mechanism arranged on the body 162. The second restrain mechanism may limit the fourth rotate member. In certain embodiments, when the cartridge 180 is not inserted into the image forming apparatus body 162, the second restrain mechanism is used to limit the fourth rotate member to a third position. The second restrain mechanism abuts against the fourth rotate member. The second restrain mechanism limits the fourth rotate member from protruding towards the cartridge 180. The fourth rotate member in the third position is not in contact with the second rotate member 186 of the cartridge 180. The fourth rotate member in the third position is not connected to the second rotate member 186 of the cartridge 180.

When cartridge 180 is inserted into and arranged in the image forming apparatus body 162, the second unlock mechanism of cartridge 180 cooperates with the second restrain mechanism to position the fourth rotate member in the fourth position, releasing the second restrain mechanism from restricting the fourth rotate member, thus enabling the second rotate member 186 to engage with the fourth rotate member. The second unlock mechanism cooperates with the second restrain mechanism. The second unlock mechanism unlocks the second restrain mechanism. In this way, the fourth rotate member in the third position may move to the fourth position. The fourth rotate member in the third position may move towards cartridge 180. The fourth rotate member in the fourth position protrudes towards the cartridge 180. The fourth rotate member in the fourth position may extend beyond the image forming apparatus body 162. The fourth rotate member in the fourth position may be locked in the axial direction to prevent axial movement and affect the transmission of drive force. The fourth rotate member in the fourth position is in contact with the second rotate member 186. The fourth rotate member in the fourth position is connected to the second rotate member 186. The fourth rotate member in the fourth position may engage with the second rotate member 186.

The process of the second unlock mechanism unlocking the second restrain mechanism is similar to the process of the first unlock mechanism 110 unlocking the first restrain mechanism 121 described above, and will not be repeated here.

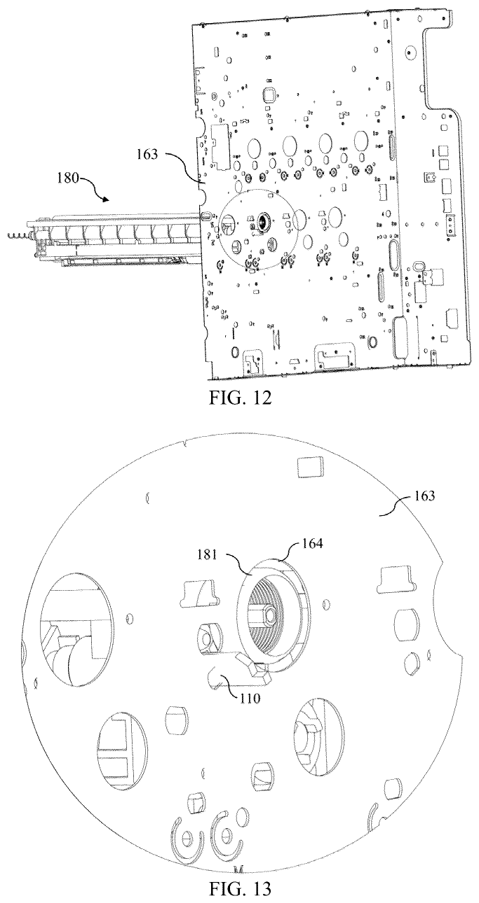

As shown in FIGS. 12 and 13, in certain embodiments, the image forming apparatus body 162 further includes a frame 163, which is provided with a mate hole 164. The first rotate member 181 may enter the interior of the image forming apparatus body 162 through the mate hole 164. When the cartridge 180 is not inserted into the image forming apparatus body 162, the first rotate member 181 may be inserted into the mate hole 164. At this time, the first unlock mechanism 110 is not released from the first restrain mechanism 121, and the first rotate member 181 and the third rotate member 166 are not in contact. The first unlock mechanism 110 may enter the interior of the image forming apparatus body 162 through the hole. When the cartridge 180 is not inserted into the image forming apparatus body 162, the first unlock mechanism 110 may be inserted into the hole. At this time, the first unlock mechanism 110 is not released from the first restrain mechanism 121, and the first unlock mechanism 110 and the third rotate member 166 are not in contact.

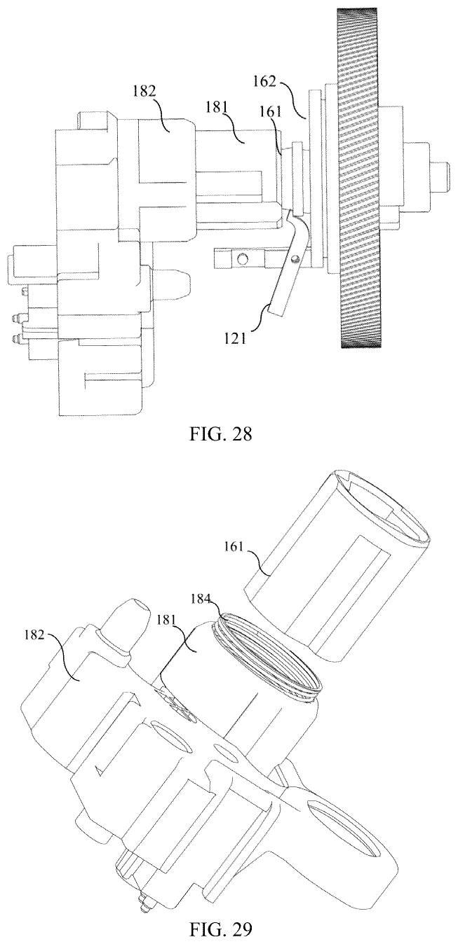

As shown in the embodiments of FIG. 28, the third rotate member 166 may maintain engagement with one gear in the gear train. The cartridge 180 does not have a first unlock mechanism 110, and the first rotate member 181 is relatively long. The third rotate member 166 retracts into the frame 163. When the cartridge 180 is installed into the image forming apparatus body 162, the first rotate member 181 extends into the image forming apparatus frame 163 and directly engages with the third rotate member 166, thereby driving the cartridge 180.

As shown in the embodiments of FIG. 29, the third rotate member 166 may maintain engagement with one gear in the gear train. The cartridge 180 does not have a first unlock mechanism 110, and the first rotate member 181 is relatively long. The first rotate member 181 is provided with a deform member 184, which may elastically extend and retract. When the cartridge 180 is installed into the image forming apparatus body 162, the first rotate member 181 extends into the image forming apparatus frame 163, and the deform member 184 may elastically engage with the third rotate member 166, thereby driving the toner cartridge.

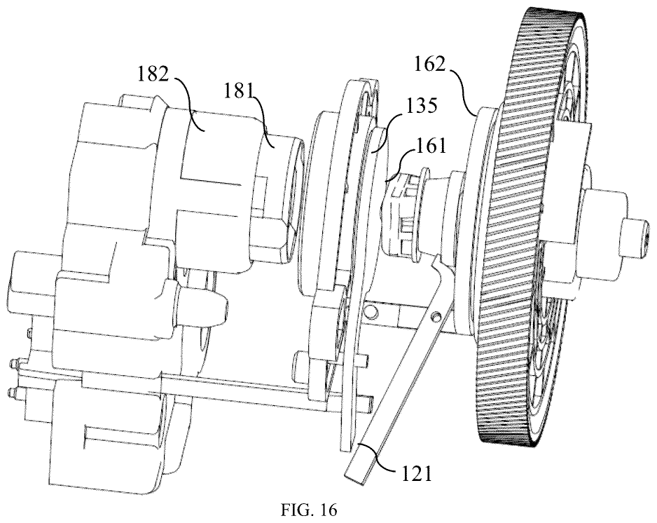

As shown in FIG. 16, in certain embodiments of the image forming apparatus, the frame 163 includes an extension for the third rotate member 166 to extend out. The extension is provided with a protect cover 135. The protect cover 135 protects the third rotate member 166, preventing foreign objects from entering and affecting the rotation of the third rotate member 166 when they fall into the frame 163. When the cartridge 180 is installed onto the image forming apparatus body 162, the first rotate member 181 opens the protect cover 135, allowing the first rotate member 181 to engage with the third rotate member 166. Preferably, the protect cover 135 may be opened by rotation or by movement.

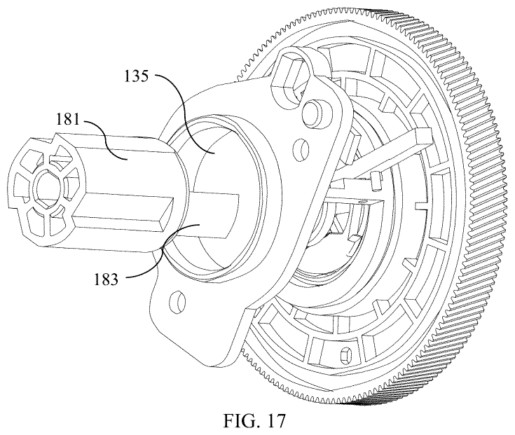

As shown in FIG. 17, in certain embodiments, the first rotate member 181 may be provided with a protrusion 183. The protrusion 183 has a pushing function. When the cartridge 180 is installed onto the image forming apparatus body 162, the protrusion 183 applies force to the protect cover 135, causing the protect cover 135 to open. This further enables the first rotate member 181 to engage with the third rotate member 166. The protrusion 183 prevents the first rotate member 181 from directly opening the protect cover 135, thereby preventing damage to the first rotate member 181.

In certain embodiments, the third rotate member 166 may remain engaged with a gear in the gear train. The first restrain mechanism 121 locks the third rotate member 166. At this time, the first unlock mechanism 110 extends into the frame 163, unlocks the first restrain mechanism 121, and the third rotate member 166 extends out of the frame 163 and engages with the first rotate member 181, thereby driving the toner cartridge.

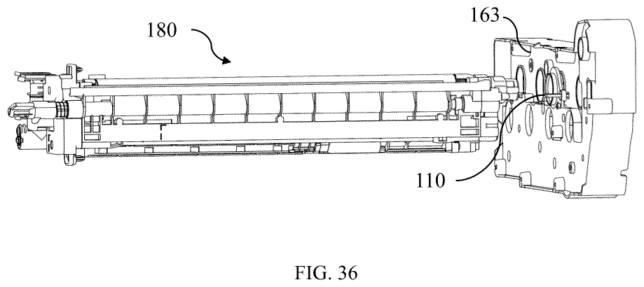

As shown in FIGS. 35 and 36, the image forming apparatus is provided with a first unlock mechanism 110. One end of the first unlock mechanism 110 may be arranged within the frame 163 of the image forming apparatus, and the other end may be arranged outside the frame 163. When the toner cartridge is installed into the image forming apparatus, due to the pushing force on the cartridge 180, the drive end face of the cartridge 180 may act on the first unlock mechanism 110, causing the first unlock mechanism 110 to move until it may open the first restrain mechanism 121. The third rotate member 166 engages with the first rotate member 181. When the cartridge 180 is removed, the first unlock mechanism 110 returns to its initial state under the action of an elastic force.

The gear mentioned above may have a single tooth or multiple teeth.

The image forming apparatus also includes a second unlock mechanism and a fourth rotate member. The implementation of the second unlock mechanism is similar to that of the first unlock mechanism 110 described above. For the sake of brevity, the present disclosure does not further elaborate on this.

In certain embodiments, the image forming apparatus further includes a photosensitive unit and a develop apparatus. The develop apparatus includes a develop container for containing a two-component developer including a toner and a magnetic carrier. The develop apparatus also includes a develop roller, which is arranged opposite to the photosensitive unit through a portion of its outer peripheral surface exposed in the opening of the develop container, and rotates such that the opposite surface of the photosensitive unit moves in an upward direction to supply toner to the photosensitive unit. The develop apparatus also includes a magnetic roller, which uses a built-in magnet to carry a developer containing toner and a magnetic carrier on its surface as a magnetic brush, and transports the carried magnetic brush. The develop roller is arranged opposite to the photosensitive unit and the magnetic roller, respectively, and carries the toner in the magnetic brush transported by the magnetic roller on its surface, and supplies the carried toner to the photosensitive unit.

Unless otherwise defined, the technical and scientific terms used herein have the same meaning as commonly understood by one of ordinary skill in the technical field. The terminology used herein is for descriptive purposes only and is not intended to limit the scope of the present disclosure. Terms such as “part” or “component” appearing herein may refer to a single part or a combination of multiple parts. Terms such as “installation” or “arrange” appearing herein may refer to one component being directly attached to another component or one component being attached to another component via an intermediary. A feature described in one embodiment herein may be applied, alone or in combination with other features, to another embodiment, unless that feature is not applicable in that other embodiment or is otherwise stated.

The present disclosure has been described through the above embodiments; however, it should be understood that the above embodiments are for illustrative purposes only and are not intended to limit the present disclosure to the described embodiments. Furthermore, those skilled in the technical field will understand that the present disclosure is not limited to the above embodiments, and many more variations and modifications may be made based on the teachings of the present disclosure, all of which fall within the scope of protection claimed in the present disclosure. The scope of protection of the present disclosure is defined by the appended claims and their equivalents.

What is claimed is:

1. A cartridge, comprising:
a housing;
a first rotate member arranged on the housing;
a first unlock mechanism for unlocking the drive force driving the first rotate member, so that the first rotate member rotates during operation.

2. The cartridge of claim 1, further comprising:
a second rotate member arranged on the housing;
a first common tangent and a second common tangent exist between a first circumcircle formed by rotation of the first rotate member and a second circumcircle formed by rotation of the second rotate member, wherein when the first unlock mechanism is at a state of unlocking the first drive source, at least a portion of the first unlock mechanism is located outside the area formed by the first common tangent and the second common tangent and the first rotate member and the second rotate member.

3. The cartridge of claim 2, further comprising:
a second unlock mechanism for unlocking the second drive source, so that the second rotate member connects to the second drive source.

4. The cartridge of claim 3, wherein when the second unlock mechanism is at state of unlocking the second drive source, at least a portion of the second unlock mechanism is located outside the area formed between the first common tangent and the second common tangent and the first rotate member and the second rotate member.

5. The cartridge of claim 1, wherein the cartridge is detachably arranged on the image forming apparatus, the image forming apparatus includes the first drive source, when the first rotate member is engaged to the first drive source, at least a portion of the first unlock mechanism protrudes beyond the first rotate member in the direction of the rotation axis of the first rotate member.

6. The cartridge of claim 3, wherein the cartridge is detachably arranged on the image forming apparatus, the image forming apparatus includes the second drive source, when the second rotate member is engaged to the second drive source, at least a portion of the second unlock mechanism protrudes beyond the second rotate member in the direction of the rotation axis of the second rotate member.

7. The cartridge of claim 1, wherein the first unlock mechanism is rotatably and/or movably connected to the cartridge.

8. The cartridge of claim 3, wherein the second unlock mechanism is rotatably and/or movably connected to the cartridge.

9. The cartridge of claim 2, wherein the first unlock mechanism is movable between the inside and outside of the area formed between the first common tangent and the second common tangent and the first rotate member and the second rotate member.

10. The cartridge of claim 1, wherein the first unlock mechanism includes a connect portion and a force-apply portion; a first connect end of the connect portion is used to connect to the housing, and a second connect end of the connect portion is used to connect to the force-apply portion; the force-apply portion is used to unlock the first drive source.

11. The cartridge of claim 10, wherein the force-apply portion includes an abut face, the force-apply portion abutting against the mate structure of the first drive source through the abut face to unlock the first drive source.

12. The cartridge of claim 11, wherein the force-apply portion further includes a protrude structure, the protrude structure protruding beyond the abut face.

13. The cartridge of claim 12, wherein the connect portion further includes a slope face, located at one end away from the protrude structure and connected to the abut face;
the force-apply portion is integrally formed with the connect portion, or the force-apply portion is detachably arranged to the connect portion.

14. The cartridge of claim 1, further comprising:
a first conductive contact and a second conductive contact, and the first unlock mechanism is located between the first conductive contact and the second conductive contact.

15. The cartridge of claim 3, wherein the first rotate member, the second rotate member, the first unlock mechanism, and the second unlock mechanism all protrude beyond the surface of the housing, the first rotate member being a drive head for the photosensitive unit, and the second rotate member being a drive head for the develop assembly.

16. The cartridge of claim 1, wherein the first unlock mechanism is integrally formed with the housing, or the first unlock mechanism is detachably arranged on the housing;
wherein the first unlock mechanisms of different sizes are respectively arranged on the cartridge containing different colors of developer;
or, the first unlock mechanisms of different sizes are respectively arranged at different positions on the cartridge containing different colors of developer.

17. An image forming apparatus, comprising:
a body provided with an insertion port for receiving a cartridge;
a third rotate member arranged on the body, the third rotate member is used to provide drive force to the cartridge ;
a first restrain mechanism arranged on the body, wherein when the cartridge is not inserted into the image forming apparatus body, the first restrain mechanism is used to limit the third rotate member to a first position; when the cartridge is inserted into the image forming apparatus body and installed in place, the first restrain mechanism is used to cooperate with the cartridge to allow the third rotate member to be positioned in a second position, thereby releasing the restriction of the first restrain mechanism on the third rotate member enable the third rotate member to provide drive force to the cartridge.

18. The image forming apparatus of claim 17, further comprising:
a fourth rotate member arranged on the body, the fourth rotate member is used to provide drive force to the cartridge;
a second restrain mechanism arranged on the body, wherein when the cartridge is not inserted into the image forming apparatus body, the second restrain mechanism is used to limit the fourth rotate member to a third position; when the cartridge is inserted into the image forming apparatus body and installed in place, a second unlock mechanism of the cartridge cooperates with the second restrain mechanism to position the fourth rotate member in a fourth position, thereby releasing the restriction of the second restrain mechanism on the fourth rotate member enable the fourth rotate member to provide drive force to the cartridge.

19. The image forming apparatus of claim 17, wherein the first restrain mechanism includes a lock member movable between a restricted position and a released position;
when the lock member is in the restricted position, it restricts the third rotate member; when the cartridge is inserted into the image forming apparatus body and installed in place, the lock member is movable to the released position under the action of the first unlock mechanism, and the lock member in the released position releases the third rotate member;
wherein the lock member includes a receive portion and a pressure-apply portion;
when the cartridge is not inserted into the image forming apparatus body, the lock member is located in the restricted position, and the pressure-apply portion abuts against the third rotate member;
during the process of inserting the cartridge into the image forming apparatus body and installing it in place, the receive portion abuts against the cartridge, and after the lock member moves from the restricted position to the released position, the pressure-apply portion releases the third rotate member;
wherein the lock member includes a rod portion, the rod portion comprising a first pressure-apply portion and a first receive portion, the first pressure-apply portion being capable of applying a compressive force to the third rotate member, and the first receive portion being capable of receiving the force applied by the cartridge;
wherein the rod portion is movable along a first direction, the first direction being parallel to the direction in which the cartridge is inserted into the body of the image forming apparatus;
wherein the first restrain mechanism further includes a connect member arranged on the body, the connect member being used to hinge the rod portion;
wherein the connect member is provided with a pivot for engaging with a groove in the rod portion, the groove being located between the first pressure-apply portion and the first receive portion; or, the connect member is provided with the groove for engaging with a pivot in the rod portion, the pivot being located between the first pressure-apply portion and the first receive portion;
wherein the first restrain mechanism further includes a first elastic member, a first end of the first elastic member being connected to the connect member, and a second end of the first elastic member being connected to the rod portion; when the lock member is in the released position and is no longer subject to the force of the first unlock mechanism, the elastic force generated by the first elastic member is used to reset the lock member to the restricted position.

20. The image forming apparatus of claim 19, wherein the lock member includes a second pressure-apply portion, the second pressure-apply portion includes a first part and a second part, the first part being connected to the second part; when the third rotate member is in the first position, the first part is used to apply a compressive force to the third rotate member; when the third rotate member is in the second position, the second part is used to release the third rotate member;
wherein the second pressure-apply portion is movable along a second direction, the second direction being perpendicular to the direction in which the cartridge is inserted into the image forming apparatus body;
wherein the lock member further includes a second receive portion, the second receive portion including a slope receive face, wherein during the insertion and installation of the cartridge into the image forming apparatus body, the slope receive face is pushed by the cartridge to move the lock member, thereby releasing the restriction of the lock member on the third rotate member;
wherein the lock member further includes a notch arranged adjacent to the slope receive surface, and the notch is used to accommodate the first unlock member of the cartridge after the housing is inserted into and installed in place within the image forming apparatus body, the first restrain mechanism being used to cooperate with the first unlock member to release the limitation of the first restrain mechanism on the third rotate member;
wherein the first restrain mechanism further includes a second elastic member, a first end of the second elastic member being connected to the lock member, and a second end of the second elastic member being connected to the body, wherein the elastic force generated by the second elastic member is used to reset the lock member to the restricted position after the lock member is no longer subjected to the force of the cartridge when it is in the released position;
image forming apparatus further comprising:
a return member, a first end of the return member being connected to the body, a second end of the return member being connected to the third rotate member, wherein when the cartridge releases the restriction of the first restrain mechanism on the third rotate member, the third rotate member may move to the second position under the action of the elastic force of the return member.
